(19) United States
(12) Patent Application Publication
(10) Pub. No.: US 2010/0079893 A1
(43) Pub. Date: Apr. 1, 2010

(54) METHOD FOR PRODUCING CONCAVO-CONVEX MEMBER, CONCAVO-CONVEX MEMBER, MAGNETIC TRANSFER METHOD, AND PERPENDICULAR MAGNETIC RECORDING MEDIUM

(75) Inventors: SOICHIRO HONDA, KANAGAWA (JP); TAKEO KIDO, KANAGAWA (JP); SEIJI KASAHARA, KANAGAWA (JP)

Correspondence Address: YOUNG & THOMPSON, 209 Madison Street, Suite 500, Alexandria, VA, 22314, US

(73) Assignee: FUJIFILM CORPORATION, TOKYO (JP)

(21) Appl. No.: 12/570,126

(22) Filed: Sep. 30, 2009

(30) Foreign Application Priority Data
Sep. 30, 2008 (JP) 2008-255118
Mar. 27, 2009 (JP) 2009-079951

(51) Int. Cl. G11B 5/02; B32B 3/02; C23C 28/00

(52) U.S. Cl. 360/55; 428/64.2; 205/183; G9B/5.026

(57) ABSTRACT

A method for producing a concaves-convex member having a concavo-convex pattern on a surface of a base material, including: forming a covering layer on surfaces of at least concave portions of an original master for producing a concavo-convex member, with a concavo-convex pattern provided on its surface; forming a barrier layer on a surface of the covering layer positioned at the at least concave portions of the original master; forming a base material by electrodepositing metal on a surface of the original master which is provided with the covering layer and the barrier layer on the at least concave portions; and separating, from the original master, the base material provided with the barrier layer and the covering layer over surfaces of at least convex portions, wherein a metal element contained in the barrier layer has an ionization tendency smaller than that of a metal element contained in the covering layer.

### BACKGROUND OF THE INVENTION

1. Field of the Invention

The present invention relates to a method for producing a concavo-convex member, such as a magnetic transfer master carrier for magnetically transfer information to a magnetic recording medium, and a mold structure for use in nano-imprinting; a concavo-convex member produced by the production method; a magnetic transfer method using the magnetic transfer master carrier; and a perpendicular magnetic recording medium prepared by the magnetic transfer method.

2. Description of the Related Art

There have been known perpendicular magnetic recording media as recording media capable of recording information at high density. An information recording area of such a perpendicular magnetic recording medium includes narrow tracks. Therefore, in a perpendicular magnetic recording medium, a servo tracking technique is important to accurately scan the narrow track width with a magnetic head and to reproduce a signal at high S/N ratio. In order to perform this tracking servo operation, it is necessary that servo information such as a tracking servo signal, an address information signal, a clock signal for reproduction, etc. be recoded on a perpendicular magnetic recording medium in advance in a so-called preformatting at predetermined intervals.

As a method for preformatting servo information on a perpendicular magnetic recording medium, for example, there is a method in which a magnetic filed for recording (transfer magnetic field) is applied to the magnetic recording medium while a magnetic transfer master carrier having, on its surface, a pattern which includes a magnetic layer and which corresponds to the servo information, closely attaching to the magnetic recording medium, so that the pattern of the magnetic transfer master carrier is magnetically transferred to the magnetic recording medium.

In this method, when a transfer magnetic field is applied to the magnetic recording medium with the magnetic transfer master carrier closely attached to the magnetic recording medium, a magnetic flux is absorbed into the magnetic layer formed in the pattern, based on the magnetization state of the magnetic transfer master carrier, and the magnetic field is intensified corresponding to the concavo-convex shape of the pattern. By applying the magnetic field that is intensified in the form of pattern, only predetermined portions in the magnetic recording medium are magnetized. For this reason, there have heretofore been used magnetic transfer master carriers having a magnetic layer which uses a magnetic material having high-saturated magnetization.

As a method for producing a magnetic transfer master carrier which has less noise components caused by magnetic transfer and is superior in transfer properties, there has been proposed a method for producing a magnetic transfer master disk, which includes a magnetic layer forming step, a reverse plate forming step and a separating step (refer to Japanese Patent Application Laid-Open (JP-A) No. 2006-216181, for example).

In the production method disclosed in JP-A No. 2006-216181, the reverse plate forming step is performed by electroforming, however, when for example, a nickel sulfamate solution is used as an electroforming solution, iron, cobalt and the like contained in a magnetic layer are dissolved by the electroforming solution and the thickness of the magnetic layer in the magnetic transfer master carrier is reduced, inconveniently resulting in degradation in transfer properties.

From the foregoing, there is desired a method capable of producing a magnetic transfer master carrier having less noise components caused by magnetic transfer and is superior in transfer properties, which enables reducing the thickness of a magnetic layer formed in the magnetic transfer master carrier.

In recent years, hard disk drives that are superior in high speed reading and writing process and low in costs have begun being incorporated in portable devices such as cellular phones, compact acoustic devices and video cameras as major storage devices. Then, a technique for increasing recording density has been required to meet the demand for further sizing down and increasing capacity.

In order to increase the recording density of hard disk drives, a method of narrowing spaces between data tracks and a method of narrowing the magnetic head width in magnetic recording media have been conventionally used; however, as spaces between data tracks are made narrow, effects of Magnetic material between adjacent tracks (crosstalk) and effects of heat fluctuation become noticeable, and recording density is limited. Therefore, there is a limitation on improvement in surface recording density by narrowing of magnetic head width or the like.

Then, as a solution to noise caused by crosstalk, magnetic recording media in a form of so-called discrete track media (DTM) have been proposed.

In discrete track media, magnetic interference between adjacent tracks is decreased by means of discrete structures in which non-magnetic guard band regions are provided between adjacent tracks so as to magnetically separate tracks from one another.

In order to produce discrete track media, a nano-imprint mold structure is necessary in which a servo pattern and a group pattern are formed. With increased demand for high density recording, it is necessary to provide fine nano-imprint mold structures having a high aspect ratio.

Here, a nano-imprint mold structure is produced by, for example, a method for producing a mold structure, as shown in FIG. 16A, which includes lithographically forming, with an electron beam (EB), a resist pattern 103 on a substrate 100 (where a SiO layer 102 is formed on a Si layer 101); etching the SiO layer 102 using the resist pattern 103 as a mask as shown in FIG. 16B; depositing, by sputtering, a Ni layer 105 in concave portions 104 of the SiO layer 102 formed by the etching as shown in FIG. 16C; electroforming the substrate 100 where the Ni layer 105 is deposited, with use of an electroforming solution (e.g. a Ni sulfamate solution), as shown in FIG. 16D; and separating a mold base material 106 having the Ni layer 105 from the substrate 100, as shown in FIG. 16E.

However, in the sputtering step in which the Ni layer is deposited at concave portions, when the aspect ratio of the concave portions is high, the coatability of the Ni layer decreases and the Ni layer is slightly dissolved in the electroforming solution, there have been problems in that portions which are not sufficiently coated with the Ni layer are caused near inside bottoms of the concave portions (refer to 110 in FIG. 17), and crevices and cavities are generated inside the mold structure (refer to 120 in FIG. 18).

When a layer made of metal (Pt, Ru, Au, Cu) other than nickel, is deposited at the concave portions, instead of the Ni layer, it is possible to improve the coatability and to prevent the Ni layer from being dissolved by the electroforming solution, but there have been problems in that wrinkles are caused due to low adhesion to the substrate, and the strength of the pattern is lessened by excessively high adhesion to the substrate, resulting in remaining of a replicate pattern formed by imprinting in the original master

BRIEF SUMMARY OF THE INVENTION

The present invention has been made to solve the aforementioned problems and to achieve objects described below. Specifically, an object of the present invention is to provide a method for producing a concavo-convex member, which can produce a concavo-convex member capable of preventing the reduction in thickness of a covering layer formed in the concavo-convex member; a concavo-convex member produced by the production method; a magnetic transfer method using the concavo-convex member; and a perpendicular magnetic recording medium prepared by the magnetic transfer method.

Another object of the present invention is to provide a method for producing a magnetic transfer master carrier, which can produce a magnetic transfer master carrier having less noise components caused by magnetic transfer and is superior in transfer properties, and which enables preventing the reduction in thickness of a magnetic layer formed in the magnetic transfer master carrier; a magnetic transfer master carrier produced by the production method; a magnetic transfer method using the magnetic transfer master carrier; and a perpendicular magnetic recording medium prepared by the magnetic transfer method.

Further, a still another object of the present invention is to provide a method for producing a mold structure, which can produce a mold structure capable of preventing the reduction in thickness of a covering layer formed in the mold structure; and a mold structure produced by the production method.

As a result of intensive studies and experiments to solve the above-mentioned problems, the present inventors have found the following. More specifically, the present inventors have found that on a surface of a covering layer (magnetic layer) positioned at surfaces of at least concave portions of an original master for producing a concavo-convex member (a magnetic transfer master carrier, a mold structure), a barrier layer containing a metal element having an ionization tendency smaller than that of a metal element contained in the covering layer (magnetic layer) is formed, and a metal is electrodeposited on a surface of the barrier layer to form a base material (a master base material, a mold base material), thereby making it possible to produce a concavo-convex member (a magnetic transfer master carrier, a mold structure) where the reduction in thickness of the magnetic layer is prevented.

Furthermore, the present inventors have found that on a surface of a magnetic layer positioned at surfaces of at least concave portions of an original master for producing a magnetic transfer master carrier, a barrier layer containing a metal element having an ionization tendency smaller than that of a metal element contained in the magnetic layer is formed, and a metal is electrodeposited on a surface of the barrier layer to form a master base material, thereby making it possible to produce a magnetic transfer master carrier which has less noise components caused by magnetic transfer and is superior in transfer properties.

The following are means for solving the above-mentioned problems:

<1> A method for producing a concavo-convex member having a concavo-convex pattern provided, on a surface of a base material, with a plurality of convex portions which are projected upwardly with respect to the surface of the base material, the method including:

forming a covering layer on surfaces of at least concave portions of an original master which is for producing a concavo-convex member and has a concavo-convex pattern on a surface thereof;

forming a barrier layer on a surface of the covering layer positioned at the at least concave portions of the original master;

forming a base material by electrodepositing a metal on a surface of the original master which is provided with the covering layer and the barrier layer on the at least concave portions; and

separating, from the original master, the base material provided with the barrier layer and the covering layer over surfaces of at least convex portions,

wherein a metal element contained in the barrier layer has an ionization tendency smaller than an ionization tendency of a metal element contained in the covering layer.

<2> The method for producing a concavo-convex member according to <1>, wherein the base material is a master base material, the concavo-convex member is a magnetic transfer master carrier, and the covering layer is a magnetic layer.
<3> The method for producing a concavo-convex member according to <2>, wherein in the formation of the magnetic layer, a magnetic layer having a thickness of 10 nm or more is formed.
<4> The method for producing a concavo-convex member according to one of <2> and
<3>, wherein in the formation of the barrier layer, a barrier layer having a thickness of 4 nm to 20 nm is formed.
<5> The method for producing a concavo-convex member according to any one of <2> to <4>, wherein the metal element contained in the magnetic layer is at least one of Fe and Co, and the metal element contained in the barrier layer is at least one selected from Ni, Cu, Ru, Ag, Pt, and Au.
<6> The method for producing a concavo-convex member according to <1>, wherein the base material is a mold base material, and the concavo-convex member is a mold structure.
<7> The method for producing a concavo-convex member according to <6>, wherein the barrier layer has a thickness of 3 nm to 7 nm.
<8> The method for producing a concavo-convex member according to one of <6> and <7>, wherein the metal element contained in the covering layer is Ni, and the metal element contained in the barrier layer is at least one selected from Cu, Ru, Pt, and Au.
<9> A concavo-convex member obtained by the method for producing a concavo-convex member according to any one of <1> to <8>.
<10> A concavo-convex member including: a base material, a concavo-convex pattern on a surface of the base material, a barrier layer, and a covering layer, the barrier layer and the covering layer being provided over surfaces of at least convex portions of the base material, wherein a metal element contained in the barrier layer has an ionization tendency smaller than an ionization tendency of a metal element contained in the covering layer.
<11> The concavo-convex member according to <10>, wherein the concavo-convex member is a magnetic transfer master carrier, the base material is a master base material, and the covering layer is a magnetic layer.
<12> The concavo-convex member according to <11>, wherein the magnetic layer has a thickness of 10 nm or more.
<13> The concavo-convex member according to one of <11> and <12>, wherein the barrier layer has a thickness of 4 nm to 20 nm.
<14> The concave-convex member according to any one of <11> to <13>, wherein the metal element contained in the magnetic layer is at least one of Fe and Co, and the metal element contained in the barrier layer is at least one selected from Ni, Cu, Ru, Ag, Pt, and Au.
<15> The concave-convex member according to any one of <11> to <14>, wherein the barrier layer and the magnetic layer are laid in this order over the surfaces of the at least convex portions of the master base material.
<16> The concavo-convex member according to <10>, wherein the concavo-convex member is a mold structure, and the base material is a mold base material.
<17> The concavo-convex member according to <16>, wherein the barrier layer has a thickness of 3 nm to 7 nm.
<18> The concavo-convex member according to one of <16> and <17>, wherein the metal element contained in the covering layer is Ni, and the metal element contained in the barrier layer is at least one selected from Cu, Ru, Pt, and Au.
<19> A magnetic transfer method including:

initially magnetizing a perpendicular magnetic recording medium by applying a magnetic field;

closely attaching the concave-convex member according to any one of <11> to <15> to the initially magnetized perpendicular magnetic recording medium; and

transferring magnetic information to the perpendicular magnetic recording medium by applying a perpendicular magnetic field whose direction is opposite to the direction of a magnetic field applied in the initial magnetization, with the perpendicular magnetic recording medium and the concave-convex member closely attached to each other.

<20> A perpendicular magnetic recording medium to which magnetic information has been transferred by the magnetic transfer method according to <19>.

The present invention can solve the various conventional problems described above and achieve the objects. More specifically, the present invention can provide a method for producing a concavo-convex member, which can produce a concavo-convex member capable of preventing the reduction in thickness of a covering layer formed in the concavo-convex member; a concavo-convex member produced by the production method; a magnetic transfer method using the concavo-convex member; and a perpendicular magnetic recording medium prepared by the magnetic transfer method.

Also, the present invention can provide a method for producing a magnetic transfer master carrier, which can produce a magnetic transfer master carrier having less noise components caused by magnetic transfer and is superior in transfer properties, and which enables preventing the reduction in thickness of a magnetic layer formed in the magnetic transfer master carrier; a magnetic transfer master carrier produced by the production method; a magnetic transfer method using the magnetic transfer master carrier; and a perpendicular magnetic recording medium prepared by the magnetic transfer method.

Further, the present invention can provide a method for producing a mold structure, which can produce a mold structure capable of preventing the reduction in thickness of a covering layer formed in the mold structure; and a mold structure produced by the production method.

### BRIEF DESCRIPTION OF THE DRAWINGS

FIG. 1A is an explanatory view illustrating a method for producing an original master for producing a magnetic transfer master carrier according to one embodiment of the present invention.

FIG. 1B is another explanatory view illustrating a method for producing an original master for producing a magnetic transfer master carrier according to one embodiment of the present invention.

FIG. 1C is still another explanatory view illustrating a method for producing an original master for producing a magnetic transfer master carrier according to one embodiment of the present invention.

FIG. 1D is yet still another explanatory view illustrating a method for producing an original master for producing a magnetic transfer master carrier according to one embodiment of the present invention.

FIG. 1E is yet still another explanatory view illustrating a method for producing an original master for producing a magnetic transfer master carrier according to one embodiment of the present invention.

FIG. 1F is yet still another explanatory view illustrating a method for producing an original master for producing a magnetic transfer master carrier according to one embodiment of the present invention.

FIG. 2 is an explanatory view illustrating an original master for producing a magnetic transfer master carrier and a magnetic layer according to one embodiment of the present invention.

FIG. 3 is an explanatory view illustrating an original master for producing a magnetic transfer master carrier, a magnetic layer and a barrier layer according to one embodiment of the present invention.

FIG. 4 is an explanatory view illustrating an original master for producing a magnetic transfer master carrier, a magnetic layer, a barrier layer and a metal plate (as a master base material) according to one embodiment of the present invention.

FIG. 5 is a partially cross-sectional view showing a magnetic transfer master carrier according to one embodiment of the present invention.

FIG. 6 is a top view showing a magnetic transfer master carrier.

FIG. 7A is an explanatory view illustrating a step of a magnetic transfer method of perpendicular magnetic recording.

FIG. 7B is an explanatory view illustrating another step of a magnetic transfer method of perpendicular magnetic recording.

FIG. 7C is an explanatory view illustrating still another step of a magnetic transfer method of perpendicular magnetic recording.

FIG. 8 is an explanatory view showing a cross-section of a slave disk.

FIG. 9 is an explanatory view showing a direction of magnetization of a magnetic layer (recording layer) after initial magnetization.

FIG. 10 is an explanatory view showing magnetic transfer.

FIG. 11 is a schematic block diagram showing a magnetic applying device for use in magnetic transfer

FIG. 12 is an explanatory view showing a direction of magnetization of a magnetic layer (recording layer) after magnetic transfer.

FIG. 13 is a graph showing changes in composition ratio between Si and Ni with respect to the depth of sputtering in Test Example 1.

FIG. 14 is an explanatory view illustrating an aspect ratio of an original master for producing a magnetic transfer master carrier.

FIG. 15 is a graph showing one example of a relationship between a pressure applied in film deposition and a density of film measured in each electric power in the case where Ni is used as a material of a barrier layer.

FIG. 16A is an illustration showing a method for producing a conventional mold structure (step 1).

FIG. 16B is an illustration showing a method for producing a conventional mold structure (step 2).

FIG. 16C is an illustration showing a method for producing a conventional mold structure (step 3).

FIG. 16D is an illustration showing a method for producing a conventional mold structure (step 4).

FIG. 16E is an illustration showing a method for producing a conventional mold structure (step 5).

FIG. 17 is an illustration showing a covering layer applied in production of a mold structure.

FIG. 18 is an illustration illustrating a crevice or cavitiy formed inside of a structure in production of a conventional mold structure.

FIG. 19 is an explanatory view illustrating an aspect ratio of an original master for producing a mold structure.

FIG. 20 is an illustration showing a covering layer applied in production of a mold structure.

FIG. 21 is an illustration showing a barrier layer formed in production of a mold

FIG. 22 is an explanatory view illustrating an original master for producing a mold structure, a covering layer, a barrier layer and a metal plate (as a mold base material) according to one embodiment of the present invention.

FIG. 23 is a partially cross-sectional view of a mold structure according to one embodiment of the present invention.

### DETAILED DESCRIPTION OF THE INVENTION

### Method For Producing Concavo-Convex Member, And Concavo-Convex Member

A method for producing a concavo-convex member according to the present invention is a production method of a concavo-convex member having a concavo-convex pattern provided, on a surface of a base material, with a plurality of convex portions which are projected upwardly with respect to the surface of the base material. The method includes a covering layer forming step, a barrier layer forming step, a base material forming step, and a separating step and further includes other steps if necessary.

A concavo-convex member according to the present invention is a concavo-convex member which includes a base material; a concavo-convex pattern provided, on a surface of the base material, with a plurality of convex portions which are projected upwardly with respect to the surface of the base material; a barrier layer; and a covering layer, the barrier layer and the covering layer being provided over surfaces of at least the convex portions of the base material, and further includes other layers if necessary.

The following explains a method for producing a magnetic transfer master carrier and a magnetic transfer master carrier according to one embodiment of the present invention.

### <Method For Producing Magnetic Transfer Master Carrier, And Magnetic Transfer Master Carrier>

The method for producing a magnetic transfer master carrier is a production method of a magnetic transfer master carrier having a concavo-convex pattern provided, on a surface of a master base material, with a plurality of convex portions which are projected upwardly with respect to the surface of the master base material. The method includes at least a magnetic layer forming step, a barrier layer forming step, a master base material forming step and a separating step and further includes other steps if necessary.

The magnetic transfer master carrier is a magnetic transfer master carrier which includes a master base material; a concavo-convex pattern provided, on a surface of the master base material, with a plurality of convex portions which are projected upwardly with respect to the surface of the master base material; a barrier layer; and a magnetic layer, the barrier layer and the magnetic layer being provided over surfaces of at least the convex portions of the master base material, and further includes other layers if necessary.

The magnetic transfer master carrier can be favorably produced by the method for producing a magnetic transfer master carrier.

### <Magnetic Layer Forming Step And Magnetic Layer>

In the magnetic layer forming step, a layer is formed on surfaces of at least concave portions of an original master for producing a magnetic transfer master carrier, provided with a concavo-convex pattern on a surface thereof.

Original Master For producing Magnetic Transfer Master Carrier

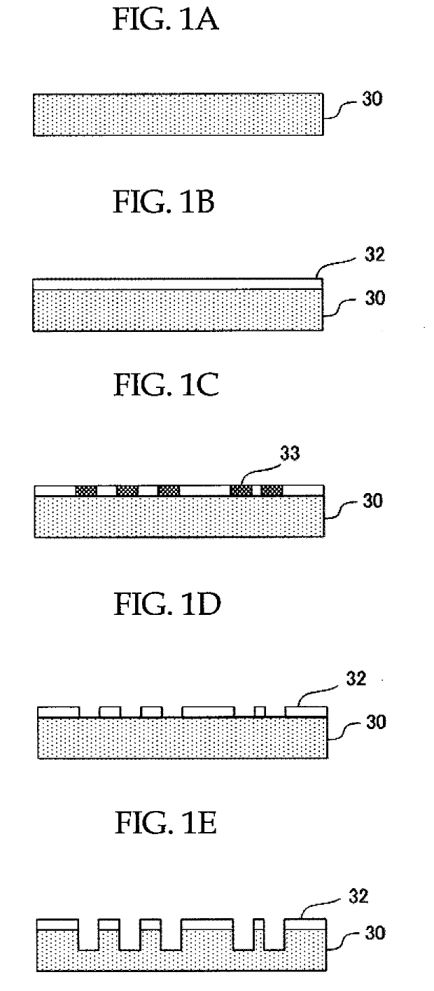

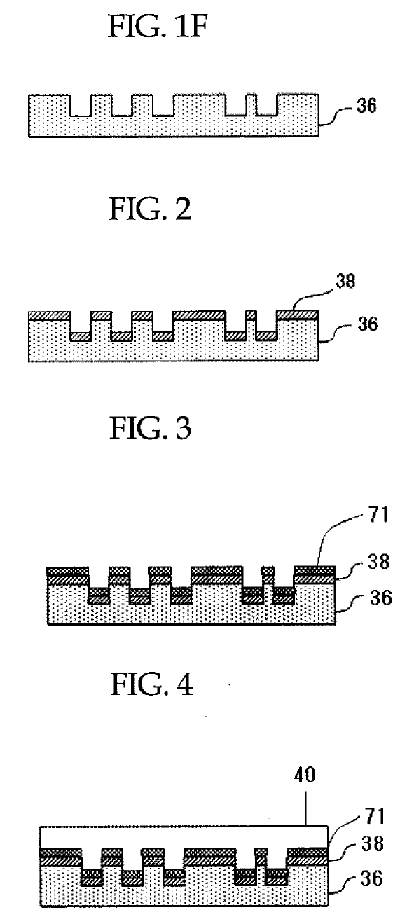

The method for producing an original master for producing a magnetic transfer master carrier, provided with a concavo-convex pattern on a surface thereof is not particularly limited and may be suitably selected in accordance with the intended use. Hereinbelow, one embodiment of the method for producing an original master for producing a magnetic transfer master carrier will be described with reference to FIGS. 1A to 1F.

As illustrated in FIG. 1A, an original plate (Si substrate) 30 which is a silicon wafer with smooth surface is prepared. On the original plate 30, an electron beam resist liquid is applied by a spin-coating method or the like so as to form a resist layer 32 thereon (refer to FIG. 1B), and the resist layer 32 is baked (pre-baked).

Next, the original plate 30 is set on a stage of an electron beam aligner not illustrated including a high precision rotary stage or X-Y stage. While the original plate 30 is rotating, an electron beam which is modulated corresponding to a servo signal is irradiated, and lithography exposure (electron beam lithography) of a predetermined pattern 33 is performed on a substantially entire surface of the resist layer 32, for example, lithographic exposure of a pattern corresponding to a servo signal linearly extending in a radius direction from a rotational center to each track is performed for the portion corresponding to each frame on the circumference (refer to FIG. 1C).

Next, as shown in FIG. 1D, the resist layer 32 is subjected to developing processing, the exposed (lithographed) portions are removed, and a covering layer of a desired thickness by the remaining resist layer 32 is formed. This covering layer becomes a mask for the next step (etching step). As the resist which is coated on the substrate 30, either a positive type or a negative type is usable, but in the positive type and the negative type, the exposed (lithographed) pattern is reversed. After the developing processing, in order to enhance the adhesion strength of the resist layer 32 and the original plate 30, baking processing (post-bake) is performed.

Next, as shown in FIG. 1E, the original plate 30 is removed (etched) by a predetermined depth from the surface from an opening of the resist layer 32. In the etching, in order to minimize undercut (side etch), anisotropic etching is desirable. As such anisotropic etching, RIE; Reactive Ion Etching can be preferably adopted.

Next, as shown in FIG. 1F, the resist layer 32 is removed. As the method for removing the resist layer 32, ashing can be adopted as a dry method, and a removal method by a stripping solution can be adopted as a wet method. By the above ashing step, an original master 36 (for producing a magnetic transfer master carrier), in which an inversion of a desired concavo-convex pattern is formed, is produced.

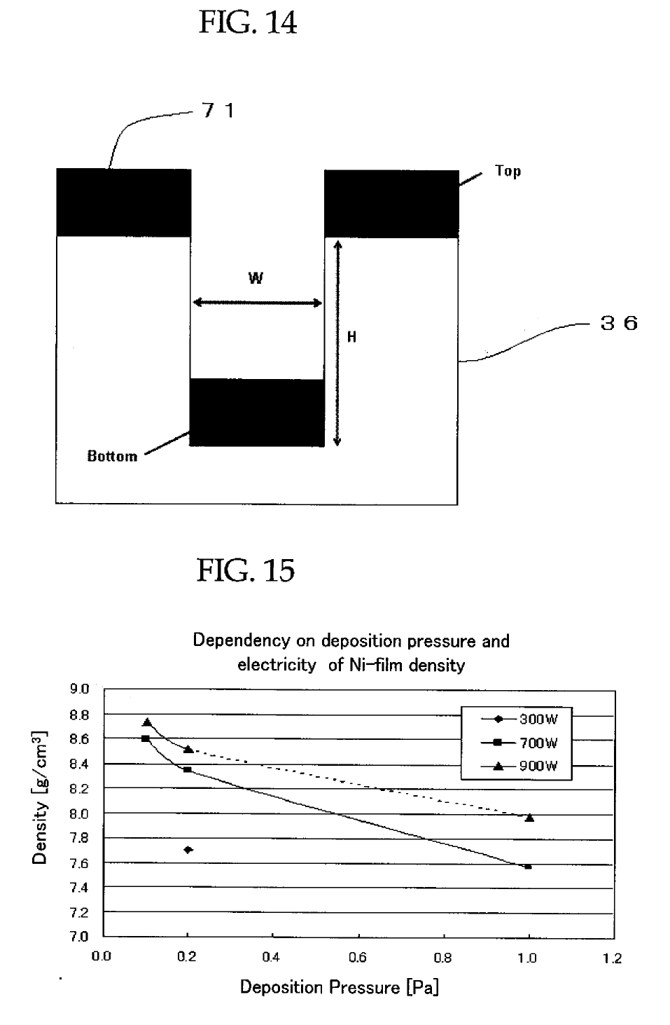

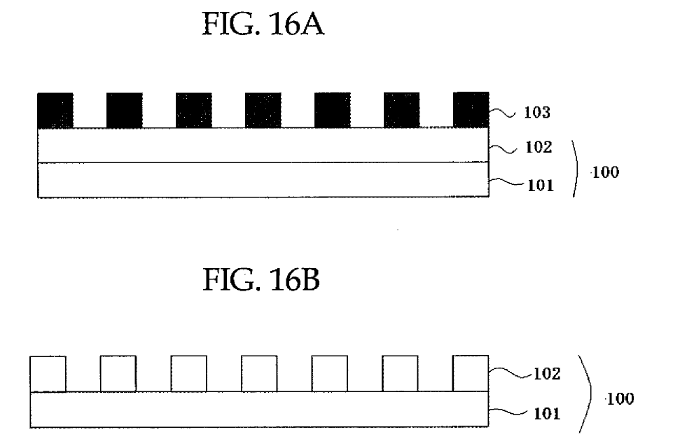

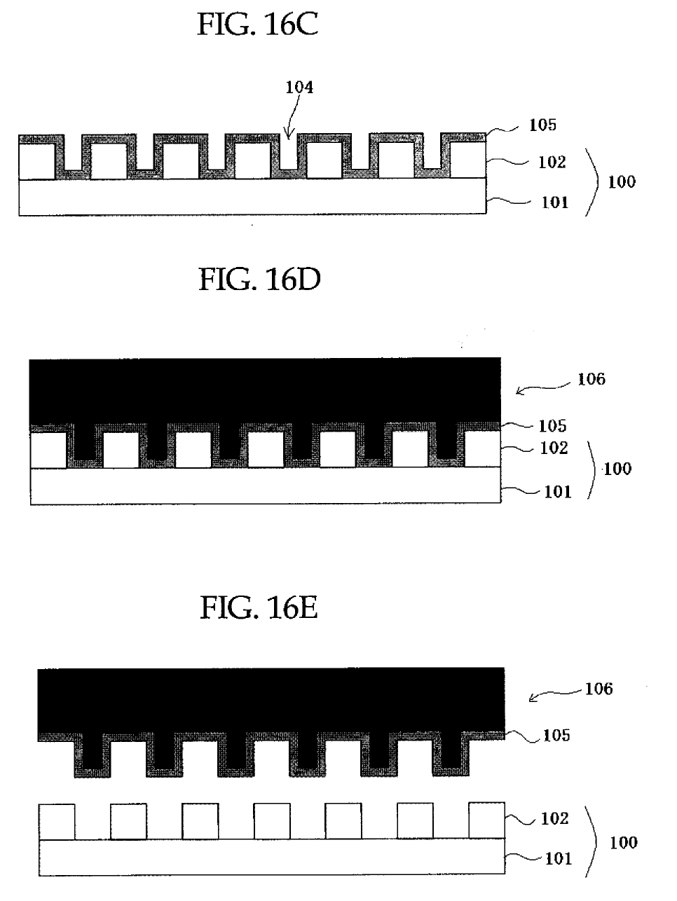

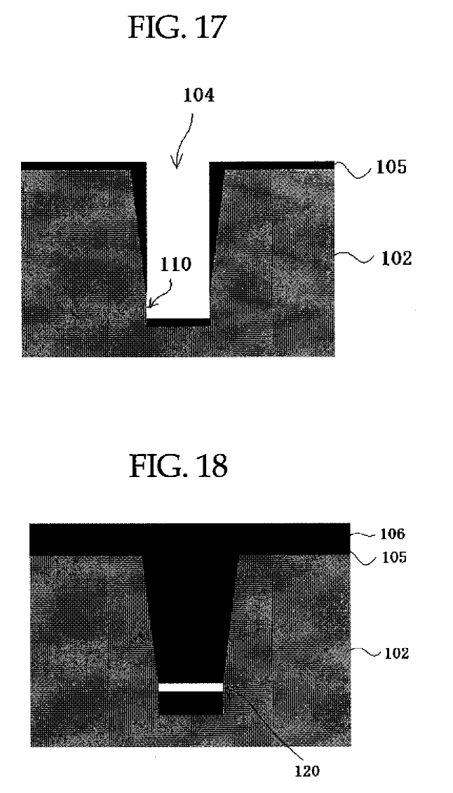

An aspect ratio (H/W) of a height (indicated by “H” in FIG. 14) of convex portions to a width (indicated by “W” in FIG. 14) of the original master for producing a magnetic transfer master carrier is not particularly limited and may be suitably adjusted in accordance with the intended use, however, it is preferably greater than 1.5 and equal to or smaller than 2.5, more preferably greater than 1.5 and equal to or smaller than 2.

When the aspect ratio (H/W) is greater than 2.5, a separating defect is liable to occur (it is difficult to separate the base material from the original master 36), and when the aspect ratio (H/W) is 1.5 or smaller, the output power of a transfer signal may become inadequate in the inner circumference and address errors may be increased in number. As a method of measuring of the aspect ratio (H/W), a method is exemplified in which a section is cut out of the original master by a FIB (manufactured by SII Nano-Technology Inc.), and the shape of the section is observed by a TEM (manufactured by Hitachi High Technologies Corporation).

Magnetic Layer

The magnetic layer is formed on surfaces of at least concave portions of the original master for producing a magnetic transfer master carrier, which has the concavo-convex pattern on the surface thereof (refer to the reference numeral 38 in FIG. 2).

The material for forming the magnetic layer 38 is not particularly limited, provided that it contains a metal element having ionization tendency greater than that of a metal element contained in the for forming the after-mentioned barrier layer, and may be suitably selected in accordance with the intended use. Examples of the material include metals, alloys and compounds each of which contain at least one selected from Fe, Co, Pt, Cr, Ni, Pd, and the like.

Among these metals, alloys and compounds, preferred are those containing at least one of Fe and Co as a main component. It is particularly desirable that the material be an alloy (FeCo) composed of Fe and Co. Use of a magnetic transfer master carrier provided with a magnetic layer composed of FeCo is advantageous in that the magnetic layer leaves less remanent magnetization, because Fe and Co are soft magnetic materials.

The method for forming the magnetic layer 38 is not particularly limited and may be suitably selected in accordance with the intended use. For example, a magnetic layer can be formed with the use of the material for forming the magnetic layer as a target by sputtering.

When FeCo is used as the material for forming the magnetic layer, the composition of the magnetic layer can be adjusted by adjusting the sputtering pressure and Fe concentration employed at the time of forming the magnetic layer.

The sputtering pressure is not particularly limited and may be suitably adjusted in accordance with the intended use. It is, however, preferably 0.01 Pa to 50 Pa, more preferably 0.01 Pa to 10 Pa. The Fe concentration is not particularly limited and may be suitably selected in accordance with the intended use. It is, however, preferably 65 atomic % to 75 atomic %, more preferably 70 atomic %.

As a sputter gas for use in forming the magnetic layer by sputtering, argon (Ar) gas can be typically used, but noble gas may also be used.

As an electric power to be charged in forming the magnetic layer by sputtering is not particularly limited and may be suitably selected in accordance with the intended use. It is, however, preferably 0.6 W/cm² to 16.0 W/cm², more preferably 3.0 W/cm² to 10.0 W/cm².

The thickness of the magnetic layer is not particularly limited and may be suitably selected in accordance with the intended use. It is, however, preferably 5 nm to 60 nm, more preferably 10 nm to 50 nm, particularly preferably 20 nm to 40 nm.

When the thickness of the magnetic layer is less than 5 nm, a SNR (a signal/noise ratio) may decrease. When the thickness is more than 60 nm, a separating defect may occur at an inner circumference of the disk. Meanwhile, when the thickness of the magnetic layer falls within the particularly preferred range, it is advantageous in terms of separation and signal quality.

As for the thickness of the magnetic layer, for example, a Kapton tape is attached onto a surface of the Si substrate and then peeled off therefrom, and a step height after the tape being peeled off is measured by a sensing pin type film thickness meter (manufactured by SLOAN Company) at five locations to obtain an average value. The average step height can be determined as the thickness of the magnetic layer.

### <Barrier Layer Forming Step And Barrier Layer>

In the barrier layer forming step, a barrier is formed on a surface of the magnetic layer positioned at the surfaces of the at least concave portions of the original master for producing a magnetic transfer master carrier.

Barrier Layer

The barrier layer is formed on a surface of the magnetic layer positioned at the surfaces of the at least concave portions of the original master for producing a magnetic transfer master carrier (refer to the reference numeral 71 in FIG. 3).

The material for forming the barrier layer 71 (barrier layer material) is not particularly limited, as long as the barrier layer material contains a metal element having an ionization tendency smaller than that of a metal element contained in the material for forming the magnetic layer (magnetic layer material), and may be suitably selected in accordance with the intended use. Examples of the material include metals, alloys and compounds each of which contain at least one selected from Ni, Cu, Ru, Ag, Pt, Au and the like.

In the case where the magnetic layer is composed of Fe and Co, the material for the barrier layer preferably has a small ionization tendency. The order of ionization tendency of the materials for forming the barrier layer is as follows: Ni>Cu>Ru>Ag>Pt>Au. When Ni is used as the material for the barrier layer, it is advantageous in terms of facilitation of sputtering and of formability of a barrier layer because Ni is greatly compatible with an electroforming layer in the electroforming process.

The method for forming the barrier layer 71 is not particularly limited and may be suitably selected in accordance with the intended use. For example, there are exemplified various metal deposition methods such as PVD (Physical Vapor Deposition), CVD (Chemical Vapor Deposition), sputtering, and ion-plating.

The sputtering pressure etc. in the sputtering process can be employed in a similar manner to the sputtering pressure etc. employed in the method for forming a magnetic layer described above.

The barrier layer is preferably formed of a dense film.

The term “dense film” means a film having a high film density.

As a method for forming the dense film, for example, in the case of using sputtering, it varies depending on the apparatus used, however, a method of forming a dense film under application of high voltage (e.g. preferably 3.0 W/cm² or higher) and low gas pressure (e.g. preferably 5 Pa or lower) is exemplified.

As a method of checking that the formed film is a dense film, for example, the film density can be measured by the X-ray total reflection method.

For example, when Ni is used and the film density is 7 (g/cm³) or more, it can be said a dense film. FIG. 15 illustrates one example of a relationship between a pressure applied in film formation and a density of film measured in each electric power in the case where Ni is used as a material for the barrier layer.

The thickness of the barrier layer is not particularly limited and may be suitably adjusted in accordance with the intended use. Specifically, the thickness of the barrier layer formed on the surface of the magnetic layer positioned at the concave portions of the original master for producing a magnetic transfer master carrier is preferably 4 nm to 20 nm, more preferably 4 nm to 10 nm, particularly preferably 4 nm to 8 nm.

When the thickness of the barrier layer formed on the surface of the magnetic layer positioned at the concave portions of the original master for producing a magnetic transfer master carrier is less than 4 nm, the barrier layer does not serve as a barrier layer, possibly resulting in dissolution of the magnetic layer. When the thickness is more than 20 nm, crevices and cavities are generated at convex portions in the inner circumference of the original master, possibly causing a separating defect at the time of separating. Meanwhile, when the thickness of the barrier layer falls within the particularly preferred range, the barrier layer surely serves as a barrier layer and it is advantageous in terms of formability of a pattern, without causing separating defects.

As for the thickness of the magnetic layer, for example, a Kapton tape is attached onto a surface of the Si substrate and then peeled off therefrom, and a step height after the tape being peeled off is measured by a sensing pin type film thickness meter (manufactured by SLOAN Company) at five locations to obtain an average value. The average step height can be determined as the thickness of the magnetic layer.

### Master Base Material Forming Step And Master Base Material

In the master base material forming step, a master base material is for Led by electrodepositing a metal on a surface of an original master for producing a magnetic transfer master carrier, provided with a magnetic layer and a barrier layer at least concave portions of the original master.

Master Baser Material

The master base material is not particularly limited and may be suitably selected in accordance with the intended use. For example, there may be exemplified known materials as metals such as nickel and aluminum.

The master base material is formed, as shown in FIG. 4, by laminating a metal plate 40 (as a master base material) made of a metal having a desired thickness over the surface of the original master 36 (for producing a magnetic transfer master carrier) by electroforming.

The master base material forming step is performed by immersing the original master 36 in an electrolytic solution placed in an electroforming device, utilizing the original master 36 as an anode, and passing an electric current between the anode and a cathode. The concentration of the electrolytic solution, the pH, the manner in which the electric current is applied, etc. are required to be adjusted under an optimized condition where the laid metal plate 40 does not warp.

### <Separating Step And Magnetic Transfer Master Carrier>

In the separating step, the master base material provided with the magnetic layer and the barrier layer on at least surfaces of the convex portions of the master base material is separated from the original master for producing a magnetic transfer master carrier.

By the separating step, it is possible to obtain a magnetic transfer master carrier having a barrier layer and a magnetic layer on at least surfaces of the convex portions of the master base material.

The magnetic transfer master carrier preferably has a structure where a barrier layer and a magnetic layer are laid in this order over the surface of the master base material.

Separating Step

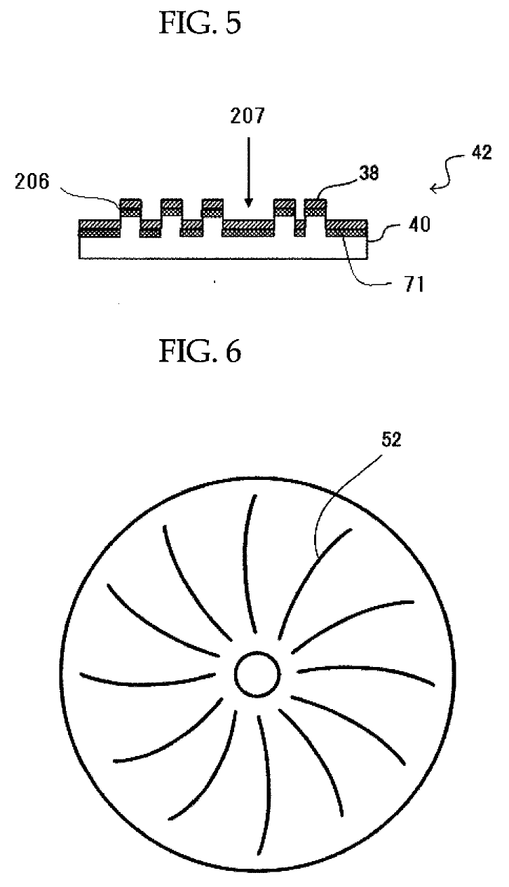

The original master 36 (for producing a magnetic transfer master carrier) over which the metal plate 40 (as a master base material) has been laid in the master base material forming step is taken out from the electrolytic solution placed in the electroforming device and then immersed in purified water placed in a release bath (not shown). Subsequently, in the release bath, the metal plate 40 is separated from the original master 36 and a magnetic transfer master carrier 42 having a concavo-convex pattern which is an inversion of the concavo-convex pattern of the original master 36 is thus obtained as shown in FIG. 5.

Magnetic Transfer Master Carrier

FIG. 5 is a partially cross-sectional view of the magnetic transfer master carrier 42. The magnetic transfer master carrier 42 is provided with the master base material 40, the barrier layer 71 formed on the surface of the master base material 40, the magnetic layer 38 formed on the surface of the barrier layer 71. The master base material 40 has convex portions 206 and concave portions 207 on its surface.

Note that in the present embodiment, the surfaces of the concave portions 207 are covered with the magnetic layer 38 for the sake of facilitation of production, etc. In other embodiments, however, provision of the magnetic layer 38 in the concave portions 207 may be omitted.

The magnetic layer 38 formed on the surfaces (apical surfaces) of the convex portions 206 of the master base material 40 serves as bit portions corresponding to transfer signals. These bit portions are portions where an initial magnetization is reversed, and are equivalent to transfer portions. Meanwhile, the concave portions 207 are equivalent to non-transfer portions where a magnetization is not reversed.

FIG. 6 is a top view showing a magnetic transfer master carrier. As shown in FIG. 6, a servo pattern 52 formed of a concavo-convex pattern is formed on the surface of the magnetic transfer master carrier.

### <Other Steps And Other Layers>

The other steps are not particularly limited, provided that they do not impair the effects of the present invention, and may be suitably selected in accordance with the intended use. Examples of the other steps include, but not limited to, a protective layer forming step, and a lubricant layer forming step. The magnetic transfer master carrier that has been separated from the original master is optionally subjected to a magnetic layer forming step for forming a magnetic layer. This magnetic layer forming step can be performed in a same manner as in the magnetic layer forming step described above.

The other layers are not particularly limited, provided that they do not impair the effects of the present invention, and may be suitably selected in accordance with the intended use. Examples of the other layers include, but not limited to, a protective layer, and a lubricant layer.

Protective Layer Forming Step And Protective Layer

In the protective layer forming step, a protective layer is formed over the surface (the magnetic layer) of the magnetic transfer master carrier.

By forming the protective layer, the mechanical strength, friction resistance and weatherability of the magnetic transfer carrier can be improved. Further, in order to enhance the adhesion between the magnetic layer and the protective layer, an adhesion reinforcing layer formed of Si or the like may be fanned on the magnetic layer before forming the protective layer.

The material for the protective layer is not particularly limited and may be suitably selected in accordance with the intended use. As the material for this protective layer, a hard carbon film is preferable, and inorganic carbon, diamond-like carbon, etc. may be used.

The method for forming the protective layer is not particularly limited and may be suitably selected in accordance with the intended use. Examples of the method include, but not limited to, sputtering, vapor deposition, coating, dip coating, and spin coating.

Lubricant Layer Forming Step And Lubricant Layer

In the lubricant layer forming step, a lubricant layer is formed on the protective layer.

The formation of the lubricant layer makes it possible to prevent the occurrence of scratches that are caused by friction generated when the magnetic transfer master carrier is in contact with the after-mentioned perpendicular magnetic recording medium and to enhance the durability of the magnetic transfer master carrier.

The material for the lubricant layer is not particularly limited and may be suitably selected in accordance with the intended use. In general, a fluorine resin such as perfluoropolyether (PFPE) can be used.

The method for forming the lubricant layer is not particularly limited and may be suitably selected in accordance with the intended use. Examples of the method include, but not limited to, spin coating, and dip coating.

The following explains a method for producing a mold structure and a mold structure according to one embodiment of the present invention.

### <Method For Producing Mold Structure And Mold Structure>

The method for producing a mold structure is a production method of a mold structure having a concavo-convex pattern provided, on a surface of a mold base material, with a plurality of convex portions which are projected upwardly with respect to the surface of the mold base material. The method includes at least a covering layer forming step, a barrier layer forming step, a mold base material forming step and a separating step, and further include other steps if necessary.

The mold structure is a mold base material which includes a mold base material; a concavo-convex pattern provided, on a surface of the mold base material, with a plurality of convex portions which are projected upwardly with respect to the surface of the mold base material; a barrier layer; and a covering layer, the barrier layer and the covering layer being provided over surfaces of at least the convex portions of the mold base material, and further includes other layers if necessary.

The mold structure can be favorably produced by the method for producing a mold structure.

### <Covering Layer Forming Step And Covering Layer>

In the covering layer forming step, a covering layer is formed on surfaces of at least concave portions of an original master which is for producing a concavo-convex member and has a concavo-convex pattern on a surface thereof.

Original Master For Producing Mold Structure

The method for producing the original master which is for producing a mold structure and has a concave-convex pattern on a surface thereof (otherwise, referred to as “original master for producing a mold structure” or “original master” simply) is not particularly limited and may be suitably selected in accordance with the intended use.

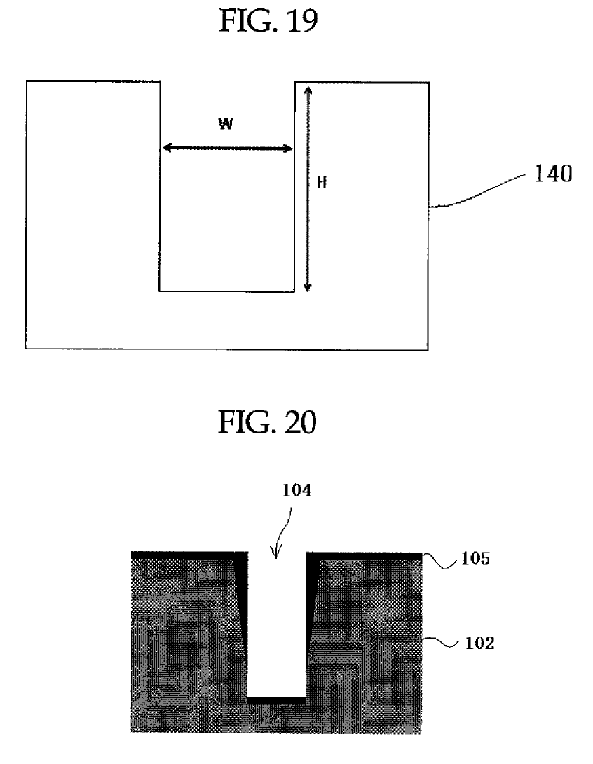

An aspect ratio (H/W) of the height (indicated by H in FIG. 19) of convex portions of the original master for producing a mold structure to the narrowest line width (indicated by W in FIG. 19) of concave portions is not particularly limited and may be suitably adjusted in accordance with the intended use. The aspect ratio is, however, preferably 2 or more.

As a method of measuring the aspect ratio (H/W), for example, there may be exemplified a method in which a section is cut out of the original master by a FIB (manufactured by SII Nano-Technology Inc.), and the shape of the section is observed by a TEM (manufactured by Hitachi High Technologies Corporation).

Note that on the surface of the original master, a concavo-convex pattern having a low aspect ratio and a wide width may be formed.

Covering Layer

The covering layer is formed on the surfaces of the at least concave portions of the original master having the pattern on its surface (refer to the reference numeral 105 in FIG. 20).

The material of forming the covering layer (covering layer material) is not particularly limited, provided that it contains a metal element having an ionization tendency greater than that of a metal element contained in the material for forming the after-mentioned barrier layer (barrier layer material), and may be suitably selected in accordance with the intended use. For example, metals, alloys and compounds each of which contain Ni are exemplified.

The method of forming the covering layer is not particularly limited and may be suitably selected in accordance with the intended use. For example, the covering layer can be formed by the use of a target of the covering layer material by sputtering.

The sputtering pressure employed in the sputtering is not particularly limited and may be suitably adjusted in accordance with the intended use. It is, however, preferably 0.3 Pa to 1 Pa, more preferably 0.1 Pa to 0.2 Pa.

As a sputter gas used in forming the covering layer by sputtering, typically, argon (Ar) gas can be typically used, but noble gas may also be used.

The electric power to be applied when forming the covering layer by sputtering is not particularly limited and may be suitably adjusted in accordance with the intended use. It is, however, preferably 0.6 W/cm² to 16 W/cm², more preferably 3.0 W/cm² to 10 W/cm².

The thickness of the covering layer is not particularly limited and may be suitably adjusted in accordance with the intended use. It is, however, preferably 3 nm to 60 nm, more preferably 3 nm to 18 nm, particularly preferably 3 nm to 9 nm.

When the thickness of the covering layer is less than 3 nm, a separating defect such as a wrinkle and called warp may occur. When the thickness is more than 60 nm, warps may occur. Meanwhile, when the thickness of the covering layer falls within the particularly preferred range, it is advantageous in that warps and wrinkles are difficult to occur.

As for the thickness of the covering layer, for example, a Kapton tape is attached onto a surface of the Si substrate and then peeled off therefrom, and a step height after the tape being peeled off is measured by a sensing pin type film thickness meter (manufactured by SLOAN Company) at five locations to obtain an average value. The average step height can be determined as the thickness of the covering layer.

### <Barrier Layer Forming Step And Barrier Layer>

In the barrier layer forming step, a barrier layer is formed on a surface of the covering layer positioned at least the concave portions of the original master for producing a mold structure.

Barrier Layer

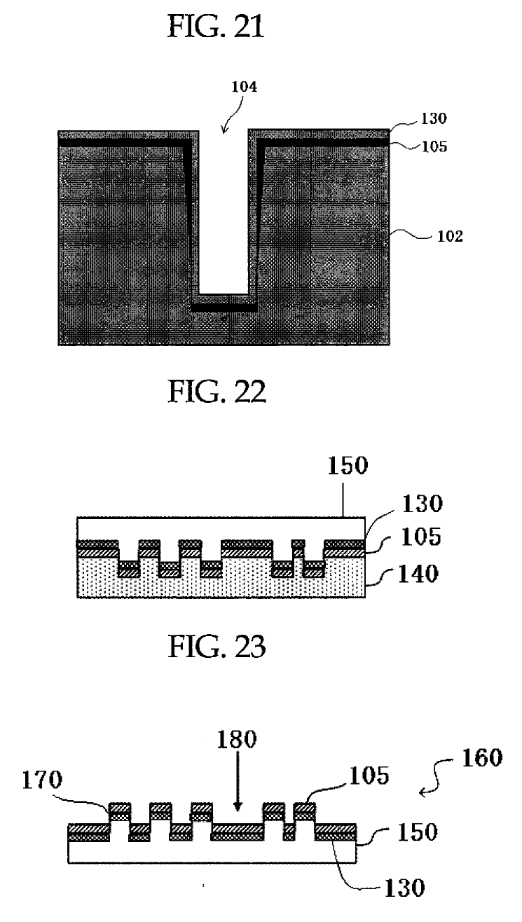

The barrier layer is formed on a surface of the covering layer positioned at surfaces of at least the concave portions of the original master for producing a mold structure (refer to the reference numeral 130 in FIG. 21).

The material for forming the barrier layer is not particularly limited, provided that it contains a metal element having an ionization tendency smaller than that of the metal element contained in the material for forming the covering layer (the covering layer material) described above, and may be suitably selected in accordance with the intended use. For example, metals, alloys and compounds each of which contain at least one selected from Cu, Ru, Pt, and Au etc. are exemplified.

In the case where the covering layer material is Ni, the barrier layer preferably has a small ionization tendency. The order of ionization tendency of the barrier layer material is as follows: Cu>Ru>Pt>Au.

The method for forming the barrier layer is not particularly limited and may be suitably selected in accordance with the intended use. For example, various metal deposition methods such as PVD (Physical Vapor Deposition), CVD (Chemical Vapor Deposition), sputtering and ion plating are exemplified.

The sputtering pressure etc. used in the sputtering can be controlled under the same conditions as in the above-mentioned sputtering for forming the covering layer.

The barrier layer is preferably formed of a dense film.

The term “dense film” means a film having a high film density.

As a method for forming the dense film, for example, in the case of using sputtering, it varies depending on the apparatus used, however, a method of forming a dense film under application of high voltage (e.g. preferably 3.0 W/cm² or higher) and low gas pressure (e.g. preferably 5 Pa or lower) is exemplified.

As a method of checking that the formed film is a dense film, for example, the film density can be measured by the X-ray total reflection method.

The thickness of the barrier layer is not particularly limited and may be suitably adjusted in accordance with the intended use. Specifically, the thickness of the barrier layer laid on the covering layer positioned at the concave portions of the original master for producing a mold structure is preferably 3 nm to 7 nm, more preferably 4 nm to 7 nm, particularly preferably 6 nm to 7 nm.

When the thickness of the barrier layer laid on the covering layer positioned at the concave portions of the original master is less than 3 nm, the barrier layer does not serve as a barrier layer, possibly resulting in dissolution of the magnetic layer. When the thickness is more than 7 nm, crevices and cavities are generated at convex portions in the inner circumference of the original master, possibly causing a separating defect at the time of separation. Meanwhile, when the thickness of the barrier layer falls within the particularly preferred range, the barrier layer surely serves as a barrier layer and it is advantageous in terms of formability of a pattern, without causing separating defects.

As for the thickness of the barrier layer, for example, a Kapton tape is attached onto a surface of the Si substrate and then peeled off therefrom, and a step height after the tape being peeled off is measured by a sensing pin type film thickness meter (manufactured by SLOAN Company) at five locations to obtain an average value. The average step height can be determined as the thickness of the barrier layer.

### <Mold Base Material Forming Step And Mold Base Material>

In the mold base material forming step, a mold base material is formed by electrodepositing a metal on the surface of an original master for producing a mold structure, provided with a covering layer and a barrier layer on at least concave portions of the original master.

Mold Base Material

The mold base material is not particularly limited and may be suitably selected in accordance with the intended use. For example, there may be exemplified known materials, including metals such as nickel and aluminum.

The mold base material is formed as follows. As shown in FIG. 22, a metal plate 150 (as a mold base material) formed of a metal having a desired thickness is laid over the surface of an original master 140 (for producing a mold structure) by electroforming.

The mold base material forming step is performed by immersing the original master 140 in an electrolytic solution placed in an electroforming apparatus, utilizing the original master 140 as an anode, and passing an electric current between the anode and a cathode. The concentration of the electrolytic solution, the pH, the manner by which the electric current is applied, etc. are required to be adjusted under an optimized condition where the laid metal plate 150 does not warp.

### <Separating Step And Mold Structure>

In the separating step, the mold base material provided with the barrier layer and the covering layer on surfaces of at least convex portions thereof is separated from the original master for producing a mold structure.

With the separating step, it is possible to obtain a mold structure in which the barrier layer and the covering layer are provided on the surfaces of the at least convex portions of the mold base material.

The mold structure preferably has a bather layer and a covering layer which are laid in this order over the surface of the mold base material.

Separating

The original master 140 (for producing a mold structure) with the metal plate 150 (as a mold base material), which has been formed in the mold base material forming step and is laid over the surface thereof is taken out from the electrolytic solution in the electroforming apparatus and then immersed in pure water placed in a release bath (not shown).

Subsequently, in the release bath, the metal plate 150 is separated from the original master 140, and a mold structure 160 having a concavo-convex pattern which is an inversion of the concavo-convex pattern of the original master 140 is thus obtained as shown in FIG. 23.

Mold Structure

FIG. 23 is a partially cross-sectional view showing a mold structure 160. The mold structure 160 includes a mold base material 150, a barrier layer 130 formed on a surface of the mold base material 150, and a covering layer 105 formed on a surface of the barrier layer 130. The mold structure 150 is provided with convex portions 170 and concave portions 180 on a surface thereof.

### <Other Steps And Other Layers>

The other steps are not particularly limited, provided that they do not impair the effects of the present invention, and may be suitably selected in accordance with the intended use. Examples of the other steps include, but not limited to, a protective layer forming step, and a lubricant layer forming step.

The other layers are not particularly limited, provided that they do no impair the effects of the present invention, and may be suitably selected in accordance with the intended use. Examples of the other layers include, but not limited to, a protective layer, and a lubricant layer.

Protective Layer Forming Step And Protective Layer

In the protective layer forming step, a protective layer is formed over the surface (the covering layer) of the mold structure.

By forming the protective layer, the mechanical strength, friction resistance and weatherability of the mold structure can be improved. Further, in order to enhance the adhesion between the covering layer and the protective layer, an adhesion reinforcing layer formed of Si or the like may be formed on the covering layer before forming the protective layer.

The material for the protective layer is not particularly limited and may be suitably selected in accordance with the intended use. As the material for this protective layer, a hard carbon film is preferable, and inorganic carbon, diamond-like carbon, etc. may be used.

The method for forming the protective layer is not particularly limited and may be suitably selected in accordance with the intended use. Examples of the method include, but not limited to, sputtering, vapor deposition, coating, dip coating, and spin coating.

Lubricant Layer Forming Step And Lubricant Layer

In the lubricant layer forming step, a lubricant layer is formed on the protective layer.

The formation of the lubricant layer makes it possible to prevent the occurrence of scratches that are caused by friction generated when the mold structure is in contact with a resist and to enhance the durability of the mold structure.

The material for the lubricant layer is not particularly limited and may be suitably selected in accordance with the intended use. In general, a fluorine resin such as perfluoropolyether (PFPE) can be used.

The method for forming the lubricant layer is not particularly limited and may be suitably selected in accordance with the intended use. Examples of the method include, but not limited to, spin coating, and dip coating.

### (Magnetic Transfer Method And Perpendicular Magnetic Recording Medium)

The magnetic transfer method of the present invention includes at least an initial magnetization step, a closely attaching step, and a magnetic transfer method, and further includes other steps if necessary.

The perpendicular magnetic recording medium of the present invention can be prepared by the magnetic transfer method of the present invention.

### <Magnetic Transfer Technique>

Firstly, a magnetic transfer technique of a perpendicular magnetic recording medium with the use of the magnetic transfer master carrier of the present invention will be explained with reference with drawings.

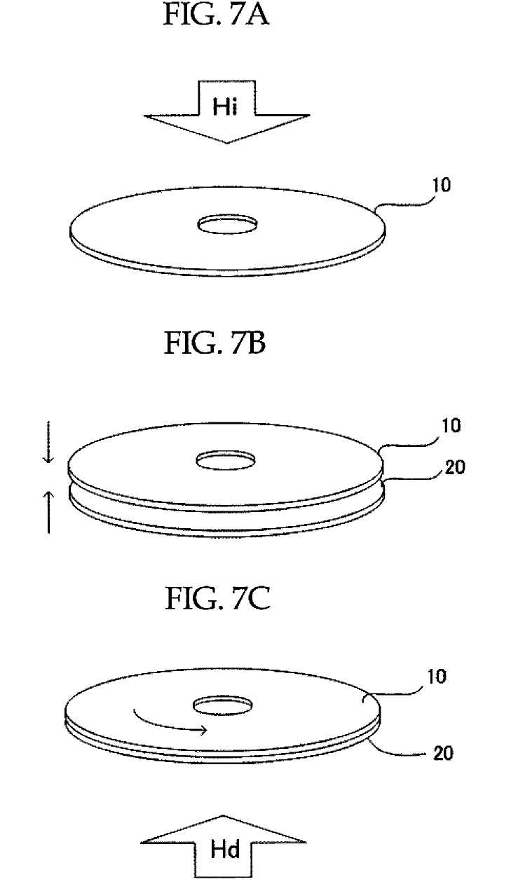

FIGS. 7A to 7C are explanatory views illustrating each step of a magnetic transfer method of perpendicular magnetic recording. In FIGS. 7A to 7C, the reference numeral 10 denotes a slave disk (which is equivalent to a perpendicular magnetic recording medium) as a magnetic disk to which information is to be transferred, and the reference numeral 20 denotes a master disk as a magnetic transfer master carrier.

As shown in FIG. 7A, a DC magnetic field (Hi) is applied to a plane surface of the slave disk 10 from a perpendicular direction so as to initially magnetize the slave disk 10 (initial magnetization step).

After the initial magnetization step, the initially magnetized slave disk 10 and the master disk 20 are closely attached to each other as shown in FIG. 7B (closely attaching step).

After these disks 10 and 20 have been closely attached to each other, a magnetic field (Hd) whose direction is opposite to the direction of the magnetic field (Hi) applied at the time of the initial magnetization, is applied to the disks as shown in FIG. 7C, such that the information possessed by the master disk 20 is magnetically transferred to the slave disk 10 (magnetic transfer step).

### <Slave Disk (Perpendicular Magnetic Recording Medium)>

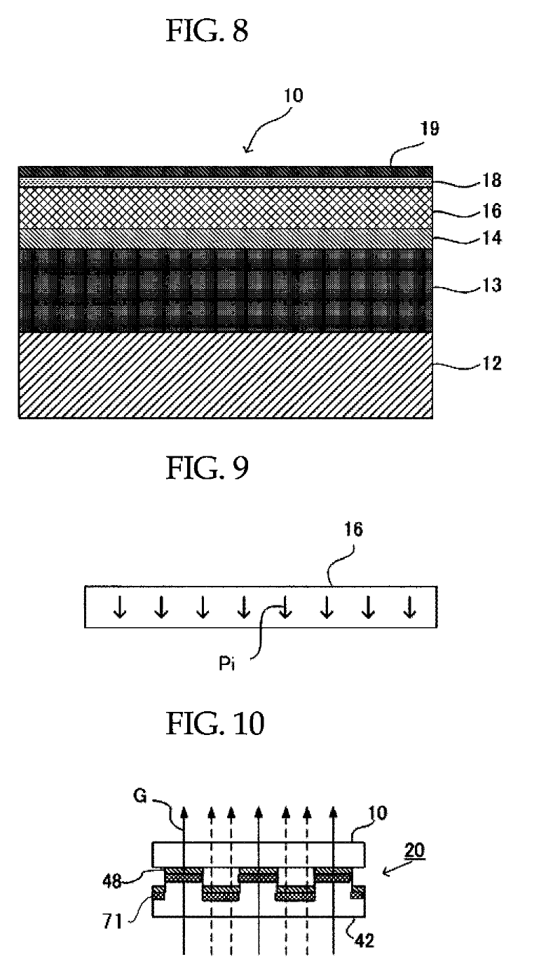

The slave disk 10 shown in FIGS. 7A to 7C includes a disc-shaped substrate, and magnetic layer(s) formed over one or both surfaces of the substrate. Specific examples thereof include high-density hard disks. The following explains a perpendicular magnetic recording medium with reference to FIG. 8 employing the slave disk 10 as an example.

FIG. 8 is an explanatory view showing a cross section of the slave disk 10. As shown in FIG. 8, the slave disk 10 includes a nonmagnetic substrate 12 made, for example, of glass and also includes a soft magnetic layer (soft magnetic underlying layer: SUL) 13, a nonmagnetic layer (intermediate layer) 14 and a magnetic layer (perpendicular magnetic recording layer) 16 formed over the substrate 12 in this order. Further, a protective layer 18 and a lubricant layer 19 are formed over the magnetic layer 16. Note that although an example in which the magnetic layer 16 is formed over one surface of the substrate 12 is herein shown, an aspect in which magnetic layers are formed over both surfaces of the substrate 12 is possible as well.

The disc-shaped substrate 12 is made of a nonmagnetic material such as glass or Al (aluminum). After the soft magnetic layer 13 is formed on the substrate 12, the nonmagnetic layer 14 and the magnetic layer 16 are formed thereon.

The soft magnetic layer 13 is useful in that the perpendicularly magnetized state of the magnetic layer 16 can be stabilized and sensitivity at the times of recording and reproduction can be improved. The material used for the soft magnetic layer 13 is preferably selected from soft magnetic materials, for example CoZrNb, FeTaC, FeZrN, FeSi alloys, FeAl alloys, FeNi alloys such as permalloy, and FeCo alloys such as permendur. This soft magnetic layer 13 is provided with magnetic anisotropy from the center of the disk toward the outside in radius directions.

The thickness of the soft magnetic layer 13 is preferably 20 nm to 2,000 nm, more preferably 40 nm to 400 nm.

The nonmagnetic layer 14 is provided in order to increase the magnetic anisotropy of the subsequently formed magnetic layer 16 in a perpendicular direction or for some other reason. As the material used for the nonmagnetic layer 14, Ti (titanium), Cr (chromium), CrTi, CoCr, CrTa, CrMo, NiAl, Ru (ruthenium), Pd (palladium), Ta, Pt or the like is preferable. The nonmagnetic layer 14 is formed by depositing the material by sputtering. The thickness of the nonmagnetic layer 14 is preferably 10 nm to 150 nm, more preferably 20 nm to 80 nm.

The magnetic layer 16 is formed of a perpendicular magnetization film which is configured such that magnetization easy axes in a magnetic layer are oriented primarily perpendicularly to the substrate, and information is to be recorded on this magnetic layer 16. The material used for the magnetic layer 16 is preferably selected from Co (cobalt), Co alloys (CoPtCr, CoCr, CoPtCrTa, CoPtCrNbTa, CoCrB, CoNi, etc.), Co alloy—SiO₂, Co alloy—TiO₂, Fe, Fe alloys (FeCo, FePt, FeCoNi, etc.) and the like. Because of high magnetic flux density, any of these materials can have perpendicular magnetic anisotropy by adjusting a deposition condition and/or its composition. The magnetic layer 16 is formed by depositing the material by means of sputtering. The thickness of the magnetic layer 16 is preferably 10 nm to 500 nm, more preferably 20 nm to 200 nm.

In the present embodiment, a disc-shaped glass substrate having an outer diameter of 65 mm is used as the substrate 12 of the slave disk 10, the glass substrate is set in a chamber of a sputtering apparatus, and the pressure is reduced to 1.33×10⁻⁵ Pa (1.0×10⁻⁷ Torr); thereafter, Ar (argon) gas is introduced into the chamber, and a first SUL having a thickness of 80 nm is deposited by sputtering with the use of a CoZrNb target provided in the chamber, the temperature of the substrate also in the chamber being set at room temperature. Subsequently, a Ru layer having a thickness of 0.8 nm is deposited on the first SUL by sputtering with the use of a Ru target provided in the chamber. Further, a second SUL having a thickness of 80 nm is deposited on the Ru layer by sputtering with the use of a CoZrNb target. The temperature of the first SUL and the second SUL formed by sputtering is set to room temperature formed, while applying a magnetic field having a strength of 50 Oe or greater in the radius directions.

Next, sputtering deposition is carried out by means of electric discharge under such a condition that the substrate temperature is made equal to room temperature, for example, with the use of a Ru target. In this manner, the nonmagnetic layer 14 formed of Ru is deposited so as to have a thickness of 60 nm.

Thereafter, in a similar manner, Ar gas is introduced, and sputtering deposition is carried out by means of electric discharge under such a condition that the substrate temperature is made equal to room temperature, with the use of a CoCrPt target provided in the same chamber. In this manner, the magnetic layer 16 which is formed of CoCrPt—SiO₂ and has a granular structure is deposited so as to have a thickness of 25 nm.

By the above-mentioned process, the transfer magnetic disk (slave disk) 10, in which the soft magnetic layer, the nonmagnetic layer and the magnetic layer have been deposited over the glass substrate, is produced.

### <Magnetic Transfer Method>

The following explains a magnetic transfer method according to one embodiment of the present invention

Initial Magnetization Step For Slave Disk

As shown in FIG. 7A, initial magnetization (DC magnetization) of the slave disk 10 is performed by generation of an initializing magnetic field Hi with the use of a device (magnetic field applying unit (not shown)) capable of applying a DC magnetic field perpendicularly to the surface of the slave disk 10. Specifically, it is performed by generating as the initializing magnetic field Hi a magnetic field which is greater than or equal to the coercive force Hc of the slave disk 10 in strength. By this initial magnetization step, the magnetic layer 16 of the slave disk 10 is subjected to an initial magnetization Pi in one direction perpendicular to the disk surface, as shown in FIG. 9. It should be noted that this initial magnetization step may be carried out by rotating the slave disk 10 relatively to the magnetic field applying unit.

Closely Attaching Step In Magnetic Transfer

Next, a step (closely attaching step) is carried out in which, as shown in FIG. 7B, the master disk 20 and the initially magnetized slave disk 10 are laid one on top of the other and closely attached to each other. In the closely attaching step, as shown in FIG. 7B, the surface of the master disk 20 on the side of the protrusion pattern (concavo-convex pattern) and the surface of the slave disk 10 on the side of the magnetic layer 16 are closely attached to each other with a predetermined pressing force.

Before closely attached to the master disk 20, the slave disk 10 is, if necessary, subjected to a cleaning process (burnishing or the like) in which minute protrusions or attached dust on its surface is removed using a glide head, a polisher, etc.

As to the closely attaching step, there is a case where the master disk 20 is closely attached to only one surface of the slave disk 10 as shown in FIG. 7B, and there is another case where master disks are closely attached to both surfaces of a transfer magnetic disk, where magnetic layers have been formed. The latter case is advantageous in that transfer to both the surfaces can be simultaneously performed.

Magnetic Transfer Step

Next, the magnetic transfer step is explained with reference to FIG. 7C. To the slave disk 10 and the master disk 20 that have been closely attached to each other by the closely attaching step, a recording magnetic field Hd is generated in the opposite direction to the direction of the initializing magnetic field Hi by a magnetic field applying unit (not shown). Magnetic transfer is performed as a magnetic flux produced by generating the recording magnetic field Hd enters the slave disk 10 and the master disk 20.

In the present embodiment, the value of the recording magnetic field Hd is approximately equal to that of the coercive force He of the magnetic material constituting the magnetic layer 16 of the slave disk 10.

In the magnetic transfer, while the slave disk 10 and the master disk 20 closely attached to each other are being rotated by a rotating unit (not shown), the recording magnetic field Lid is applied by the magnetic field applying unit, and information in the form of the protrusion pattern, recorded on the master disk 20, is magnetically transferred to the magnetic layer 16 of the slave disk 10. Apart from this structure, a mechanism for rotating the magnetic field applying unit may be provided such that the magnetic field applying unit is rotated relatively to the slave disk 10 and the master disk 20.

FIG. 10 shows a cross section of the slave disk 10 and the master disk 20 in the magnetic transfer step. When the recording magnetic field Hd is applied with the slave disk 10 closely attached to the master disk 20 having the concavo-convex pattern as shown in FIG. 10, a magnetic flux G becomes strong in areas where the convex portions of the master disk 20 and the slave disk 10 are in contact with each other, the recording magnetic field Hd causes the magnetization direction of the magnetic layer 48 of the master disk 20 to align with the direction of the recording magnetic field Hd, and thus the magnetic information is transferred to the magnetic layer 16 of the slave disk 10. Meanwhile, at the concave portions of the master disk 20, the magnetic flux G generated by the application of the recording magnetic field is weaker than at the convex portions, and the magnetization direction of the magnetic layer 16 of the slave disk 10 does not change, so that the initially magnetized state remains unchanged.

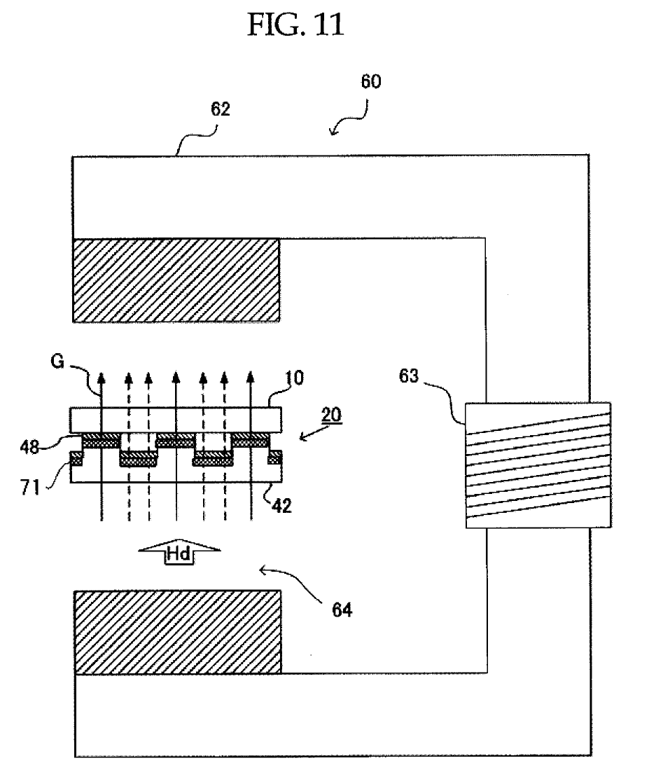

FIG. 11 shows in a detailed manner a magnetic transfer apparatus used for magnetic transfer. The magnetic transfer apparatus includes a magnetic field applying unit 60 composed of an electromagnet which is formed by winding a coil 63 around a core 62. By applying an electric current to the coil 63, a magnetic field is generated in a gap 64 perpendicularly to the master disk 20 and the magnetic layer 16 of the slave disk 10 which are closely attached to each other. The direction of the magnetic field generated can be changed depending on the direction of the electric current applied to the coil 63. Therefore, both initial magnetization of the slave disk 10 and magnetic transfer can be performed by this magnetic transfer apparatus.

In the case where magnetic transfer is carried out after initial magnetization is performed, using this magnetic transfer apparatus, an electric current which flows in the opposite direction to the direction of an electric current applied to the coil 63 of the magnetic field applying unit 60 at the time of the initial magnetization is applied to the coil 63. This makes it possible to generate a recording magnetic field in the opposite direction to the magnetization direction at the time of the initial magnetization. In the magnetic transfer, while the slave disk 10 and the master disk 20 closely attached to each other are being rotated, the recording magnetic field Hd is applied by the magnetic field applying unit 60, and the information in the form of the protrusion pattern, recorded on the master disk 20, is magnetically transferred to the magnetic layer 16 of the slave disk 10; accordingly, a rotating unit (not shown) is provided. Apart from this structure, a mechanism for rotating the magnetic field applying unit 60 may be provided such that the magnetic field applying unit 60 is rotated relatively to the slave disk 10 and the master disk 20.

In the present embodiment, magnetic transfer is performed by applying as the recording magnetic field Hd a magnetic field which is equivalent in strength to 40% to 130%, preferably 50% to 120%, of the coercive force He of the magnetic layer 16 of the slave disk 10 used in the present embodiment.

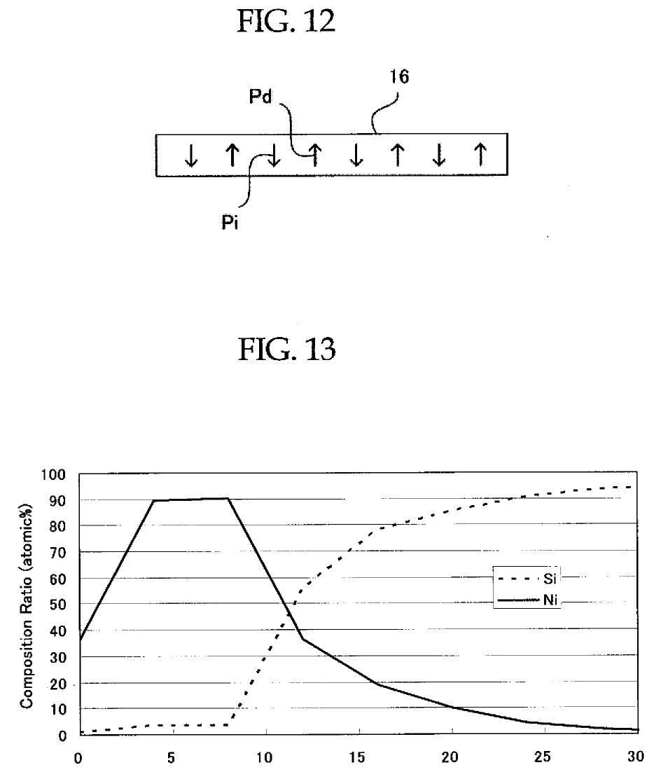

With this, on the magnetic layer 16 of the slave disk 10, information of a magnetic pattern, such as a servo signal, is recorded as a recording magnetization Pd which acts in the opposite direction to the direction of the initial magnetization Pi (refer to FIG. 12).

In carrying out the present invention, the protrusion pattern formed on the master disk 20 may be a negative pattern, as opposed to the positive pattern explained with FIG. 5. In this case, a similar magnetization pattern can be magnetically transferred to the magnetic layer 16 of the slave disk 10 by reversing the direction of the initializing magnetic field Hi and the direction of the recording magnetic field Hd. Also, although a case where the magnetic field applying unit is an electromagnet has been explained in the present embodiment, a permanent magnet which similarly generates a magnetic field may be used as well.

A perpendicular magnetic recording medium produced by the method according to the above-mentioned embodiment of the present invention will be used, installed in a magnetic recording and reproducing device such as a hard disk device, for example. This makes it possible to obtain a high-recording-density magnetic recording and reproducing device with high servo precision and excellent recording and reproducing properties.

Since the magnetic transfer master carrier of the present invention can be obtained by the method for producing a magnetic transfer master carrier, the method being capable of preventing the reduction in thickness of a magnetic layer, and the magnetic transfer master carrier has less noise components and is superior in transfer properties, it can be favorably used for transferring magnetic information to magnetic recording media.

### EXAMPLES

Hereinbelow, the present invention will be described in more detail with reference to specific examples. It should, however, be noted that the present invention is not limited to these examples.

### Test Example 1-A

### Discrimination of Metal Serving As Barrier Layer (1)

Each of the metals shown in Table 1 was deposited by 20 nm in thickness on a Si substrate by sputtering. Thereafter, the Si substrate was immersed in a nickel sulfamate solution (equivalent to an electroforming solution) described below for 2 hours. The surface of the immersed substrate (metal surface) was irradiated with accelerating argon ions by means of an X-ray photoelectron analyzer (ESCA, manufactured by Shimadzu/marketed by KRATPS, trade name: AXIS-HS), a section was cut off from the metal surface, and a compositional change from the metal surface toward the the substrate surface in a depth direction was measured.

Sputtering Conditions
argon pressure: 0.1 Pa
distance between substrate and target: 300 mm
electric power applied (DC power source): 900 W
apparatus: Ni sputtering apparatus (manufactured by Fuji Daiichi Seisakusho Co., Ltd.)

### Nickel Sulfamate Solution

| | |
|---|---|
| nickel sulfamate | 600 g/L |
| boric acid | 40 g/L |
| surfactant (sodium lauryl sulfate) | 0.15 g/L |

pH 4
temperature: 55° C.

Evaluation

When a point of intersection (intersection point) of a composition ratio between Si and each metal relative to a depth of sputtering was 10 nm or more, it was judged that the metal would serve as a barrier layer, i.e. the metal would not be dissolved in the electroforming solution. The term “a point of intersection” means an interface between Si and each metal. The reference value of the intersection being 10 nm or more was determined for the following reason. In view of measurement errors, when the intersection point value is less than 10 nm, the metal employed is possibly dissolved in the electroforming solution in the immersion process. Therefore, the reference value was set under the condition that the metal can serve as a barrier layer when the intersection point value is 10 nm or more.

The measurement results are shown in Table 1. FIG. 13 is a graph showing changes in composition ratio between Si and Ni with respect to the depth of sputtering in the case where Ni is used as the metal.

TABLE 1

| | Kind of metal | | | | | | | |
|---|---|---|---|---|---|---|---|---|
| | Fe | Co | Ni | Cu | Ru | Ag | Pt | Au |
| Judgment of | Dissolved | Dissolved | Not | Not | Not | Not | Not | Not |
| solubility | | | dissolved | dissolved | dissolved | dissolved | dissolved | dissolved |

The results shown in Table 1 demonstrated that Ni, Cu, Ru, Ag, Pt, and Au are metals capable of serving as the above-mentioned barrier layer.

### Test Example 1-B

### Discrimination of Metal Serving As Barrier Layer (2))

A test was performed in the same manner as in Test Example 1-A, except that on the surface of Si substrate, a metal serving as a first layer shown in Table 2 was deposited to a thickness of 10 nm by sputtering, and thereafter another metal serving as a second layer shown in Table 2 was deposited to a thickness of 10 nm over the first layer by sputtering. Thereafter, each metal was evaluated whether the metal was capable of serving as a barrier layer. The evaluation results are shown in Table 2.

TABLE 2

| | |
|---|---|
| Kind of Metal | Judgment of |

| First layer | Second layer | solubility |
|---|---|---|
| Ni | Ru | Not dissolved |
| Ni | Cu | Not dissolved |
| Ni | Ag | Not dissolved |
| Ni | Pt | Not dissolved |
| Ni | Au | Not dissolved |
| Ru | Cu | Not dissolved |
| Ru | Ag | Not dissolved |
| Ru | Pt | Not dissolved |
| Ru | Au | Not dissolved |
| Cu | Ag | Not dissolved |
| Cu | Pt | Not dissolved |
| Cu | Au | Not dissolved |
| Ag | Pt | Not dissolved |
| Ag | Au | Not dissolved |

The results shown in Table 2 demonstrated that even when two metals each of which have an ionization tendency smaller than those of Fe and Co are used, these two metals serve as a barrier layer.

### Test Example 2

### Examination of Thickness of Barrier Layer

On a surface of a Si substrate, a magnetic layer having a thickness of 50 nm was formed with the use of FeCo (Fe 70 atomic % -Co 30 atomic %) as a material for the magnetic layer by sputtering. Next, on the surface of the magnetic layer, a barrier layer having a thickness shown in Table 2 with the use of Ni as a material for the barrier layer in the same manner as in Test Example 1. Subsequently, the substrate was immersed in the same nickel sulfamate solution (equivalent to an electroforming solution) as used in Test Example 1 for 2 hours.

After the immersion, changes in thickness of the barrier layer and the magnetic layer were analyzed by means of an X-ray photoelectron analyzer (ESCA, manufactured by Shimadzu/marketed by KRATPS, trade name: AXIS-HS)

Sputtering Conditions (Formation of Magnetic Layer)
argon pressure: 0.04 Pa
distance between substrate and target: 300 mm
electric power applied (DC power source): 500 W
apparatus: CASPER (manufactured by Canon Anelva Corporation)

Evaluation

Changes in total thickness of the barrier layer and magnetic layer were evaluated based on the following criteria. The evaluation results are shown in Table 3.

A: Not dissolved at all

B: Almost not dissolved

C: Slightly dissolved

D: Apparently dissolved

TABLE 3

| | Thickness of barrier | | | | | | |
|---|---|---|---|---|---|---|---|
| | layer (nm) | | | | | | |
| | 1 | 2 | 3 | 4 | 10 | 20 | 30 |
| Change in total | D | C | C | B | A | A | A |
| thickness of barrier | | | | | | | |
| layer and magnetic | | | | | | | |
| layer | | | | | | | |

The results shown in Table 3 demonstrated that it is necessary for the barrier layer to have a thickness of 4 nm or more. In addition, it was understood that a barrier layer having a thickness of 10 nm or more is more excellent in resistance to solubility.

### Example 1, Comparative Examples 1 And 2

A magnetic transfer master carrier (provided with a barrier layer) of Example 1 and magnetic transfer master carriers (provided with no barrier layer) of Comparative Examples 1 and 2 were produced according to the following manner. Also, a perpendicular magnetic recording medium was produced, and information was magnetically transferred from each of the resulting magnetic transfer master carriers to the perpendicular magnetic recording medium.

### <Production of Magnetic Transfer Master Carrier>

Production of Original Master For Producing Magnetic Transfer Master Carrier

Onto an 8-inch Si (silicon) wafer substrate, an electron beam resist was applied to a thickness of 100 nm by spin coating. Subsequently, the resist applied over the substrate was exposed by a rotary electron beam exposing device, and the resist that had been subjected to exposure was developed, thereby producing a resist Si substrate having a concavo-convex pattern.

Thereafter, the substrate thus produced was subjected to reactive ion etching using the resist as a mask so as to dig concave portions of the concavo-convex pattern deeper. After the etching treatment, a resist residue remaining on the substrate was washed with a resist-soluble solvent so as to remove the resist residue. The substrate from which the resist residue had been removed was dried, and the substrate was taken as an original master for producing a magnetic transfer master carrier.

It should be noted that the pattern used in Example 1 is composed of a data area and a servo area, if broadly classified. The data area was formed of a concavo-convex pattern each of the convex portions had a width of 90 nm and each of the concave portions had a width of 30 nm (Track Pitch=120 nm). The servo area had a reference signal length of 80 nm and the total sector number of 120 and was formed of a pattern of a preamble area (40 bit), a SAM area (6 bit), a sector code (Sectorcode) area (8 bit) and a cylinder code (ClinderCode) area (32 bit); and a Burst area employs a typical 4-Burst area (each burst area: 16 bit). The SAM area employed the number “001010”. The concavo-convex pattern in the sector code area was formed by Binary conversion. The concavo-convex pattern in the cylinder code area was formed by Gray conversion and then formed by Manchester conversion.

Formation of Magnetic Layer

Over the original master for producing a magnetic transfer master carrier, a magnetic layer composed of FeCo (Fe 80 atomic %-Co 20 atomic %) was formed by sputtering under an argon pressure of 0.04 Pa so as to have a thickness of 30 nm. The sputtering conditions employed in forming the magnetic layer are described below.

### [Sputtering Conditions]

argon pressure: 0.04 Pa
distance between substrate and target: 300 mm
electric power applied (DC power source): 500 W
apparatus: CASPER (manufactured by Canon Anelva Corporation)

Formation of Barrier Layer

Over the surface of the magnetic layer of the original master for producing a magnetic transfer master carrier, a barrier layer composed of Ni (nickel) was formed by sputtering so as to have a thickness of 6 nm. The sputtering conditions employed in forming the barrier layer are described below.

### [Sputtering Conditions]

argon pressure: 0.1 Pa
distance between substrate and target: 300 mm
electric power applied (DC power source): 900 W
apparatus: Ni sputtering apparatus (manufactured by Fuji Daiichi Seisakusho Co., Ltd.)

Formation of Master Base Material

The original master over which the barrier layer had been formed was immersed in a Ni sulfamate bath. After 30 seconds of immersion, a master base material (Ni film) having a thickness of 200 μm was formed by electrolytic plating.

### [Ni Sulfamate Bath]

| | |
|---|---|
| nickel sulfamate | 600 g/L |
| boric acid | 40 g/L |
| surfactant (sodium lauryl sulfate) | 0.15 g/L |

pH 4
temperature: 55° C.

Separating

After the master base material was formed, the master base material was separated from the original master for producing a magnetic transfer master carrier, and washed to thereby obtain a magnetic transfer master carrier of Example 1 which was composed of a master base material, a barrier layer and a magnetic layer.

A magnetic transfer master carrier of Comparative Example 1 was obtained in the same manner as in Example 1 except that a barrier layer was not formed.

Further, a magnetic transfer master carrier of Comparative Example 2 was obtained in the same manner as in Example 1 except that a barrier layer was not formed, and in the forming of the master base material, the time spent from the moment of the immersion of the master carrier in a Ni sulfamate bath till the electrolytic plating was started was changed to 60 seconds.

### <Production of Perpendicular Magnetic Recording Medium>

Over a 2.5 inch-glass substrate, a soft magnetic layer, a first non-magnetic orientation layer, a second non-magnetic orientation layer, a magnetic recording layer and a protective layer were formed by sputtering in this order. Further, on the protective layer thus formed, a lubricant layer was formed by dipping.

As materials of the soft magnetic layer, CoZrNb were used and a CoZrNb layer having a thickness of 100 nm was formed. Specifically, the glass substrate was placed facing a CoZrNb target, and Ar gas was injected so that the Ar gas pressure became 0.6 Pa, at DC 1,500 W, thereby depositing the soft magnetic layer.

The first non-magnetic orientation layer was formed of Ti and had a thickness of 5 nm, and the second non-magnetic orientation layer was formed of Ru and had a thickness of 6 mu.

Specifically, the soft magnetic layer deposited over the substrate was placed facing a Ti target, and then Ar gas was injected such that its pressure became 0.5 Pa and a Ti seed layer having a thickness of 5 nm was deposited by discharging at DC 1,000 W, thereby depositing the first non-magnetic orientation layer. Subsequently, the first non-magnetic orientation layer deposited over the substrate was placed facing a Ru target, and then Ar gas was injected such that its pressure became 0.8 Pa, and a Ru layer having a thickness of 6 nm was deposited by discharging at DC 900 W, thereby depositing the second non-magnetic orientation layer.

Subsequently, as the magnetic recording layer, a CoCrPtO layer having a thickness of 18 nm was formed. Specifically, the second non-magnetic orientation layer deposited over the substrate was placed facing a CoCrPtO target, and then Ar gas containing 0.06% of O₂ was injected such that its pressure became 14 Pa, and then the magnetic recording layer was deposited by discharging at DC 290 W.

The magnetic recording layer deposited over the substrate was placed facing a C (carbon) target, and then Ar gas was injected such that its pressure became 0.5 Pa, and then a protective layer having a thickness of 4 nm was deposited by discharging at DC 1,000 W. The coercive force of the magnetic recording medium was 334 kA/m (4.2 kOe).

Further, a PFPE lubricant was applied onto the magnetic recording medium by dipping, so that the lubricant layer had a thickness of 2 nm.

By the manner described above, a perpendicular magnetic recording medium was produced.

### <Magnetic Transfer>

The perpendicular magnetic recording medium was subjected to initial magnetization (initial magnetization step). The strength of a magnetic field applied in the initial magnetization (initial magnetic field strength) was 10 kOe.

The master carrier was placed facing the initially magnetized perpendicular magnetic recording medium and then closely attached to the perpendicular magnetic recording medium at a pressure of 0.7 MPa (closely attaching step). Magnetic information was transferred to the perpendicular magnetic recording medium by applying a magnetic field, with the master carrier and the perpendicular magnetic recording medium closely attached to each other (magnetic transfer step). The strength of the magnetic field used in the magnetic transfer was 4.6 kOe. Upon completion of the application of the magnetic field, the master carrier was separated from the perpendicular magnetic recording medium.

### <Evaluation>

The quality of transfer signals that had been recorded on the perpendicular magnetic recording medium through the magnetic transfer was evaluated. Specifically, for the whole sectors located at a 15 mm radius position of the recording medium, a SNR (signal/noise ratio) of reproduction output power from TAA (Track Average Amplitude) in its preamble area was calculated, and evaluated in accordance with the following criteria. The evaluation results are shown in Table 4.

Note that as an evaluation apparatus, LS-90 manufactured by Kyodo Densi Inc. was used and a GMR head with a read width of 120 nm and a write width of 200 nm was used.

A: 12 dB or more

B: More than 10 dB and less than 12 dB

C: 10 dB or less

TABLE 4

| | | Comparative | Comparative |
|---|---|---|---|
| | Example 1 | Example 1 | Example 2 |
| Evaluation | A | B | C |

The results shown in Table 4 demonstrated that the perpendicular magnetic recording medium of Example 1 provided with a barrier layer had the highest SNR and was superior in transfer properties to those of Comparative Examples 1 and 2. Also, the thickness of each magnetic layer of the perpendicular magnetic recording media was measured. As a result of the measurement, the thickness of the magnetic layer did not change in Example 1. In contrast to Example 1, in Comparative Example 1, the thickness of the magnetic layer was reduced by 10 nm; and in Comparative Example 2, the thickness of the magnetic layer was reduced by 20 nm.

It can be demonstrated from the test results shown above that the method for producing a magnetic transfer master carrier of the present invention is capable of preventing the reduction in thickness of a magnetic layer, and a magnetic transfer master carrier produced by the method has less noise components caused by magnetic transfer and is superior in transfer properties.

### Test Example 3

### Examination of Coatability And Separatability

### <Production of Original Master For Producing Mold Structure>

Onto an 8-inch Si (silicon) wafer substrate, an electron beam resist was applied to a thickness of 100 nm by spin coating. Subsequently, the resist applied over the substrate was exposed by a rotary electron beam exposing device, and the resist that had been subjected to exposure was developed, thereby producing a resist Si substrate having a concavo-convex pattern.

Thereafter, the substrate thus produced was subjected to reactive ion etching using the resist as a mask so as to dig concave portions of the concavo-convex pattern deeper (concave portions with an aspect ratio of 3 relative to the narrowest line width). After the etching treatment, a resist residue remaining on the substrate was washed with a resist-soluble solvent so as to remove the resist residue. The substrate from which the resist residue had been removed was dried, and the substrate was taken as an original master for producing a mold structure. As to the concavo-convex pattern formed on the Si substrate, a coat film was deposited, with the use of Au, Pt, Cu, and Ru, respectively, on surfaces of the concave portions by sputtering under the following sputtering conditions. A cross-section of the concave portions over which the coat film had been deposited was observed by a transmission electron microscope (TEM), and evaluated for the coatability in accordance with the following criteria. As for the separatability, a cross-cut tape test was performed for evaluation. Specifically, a cross-cut tape was attached onto a surface of the coat film and then peeled off therefrom. The separatability was evaluated according to how much the coat film peeled off and how much a peeled film adhered to the cross-cut tape. For example, if the peeled film adhered to a cross-cut tape at a rate less than 20% with respect to the surface area of the cross-cut tape, the separatability was graded A; if the peeled film adhered to a cross-cut tape at a rate of equal to 20% or more and less than 60% with respect to the surface area of the cross-cut tape, the separatability was graded B; and if the peeled film adhered to a cross-cut tape at a rate of 60% or more with respect to the surface area of the cross-cut tape, the separatability was graded C.

Sputtering Conditions (Formation of Coat Film)
argon pressure: 1 Pa
distance between substrate and target: 200 mm
electric power applied (DC power source): 500 W
apparatus: sputtering apparatus (OCTAVA II, manufactured by Shibaura Mechatronics Corporation)

Evaluation of Coatability

Each metal was evaluated for the coatability. The results are shown in Table 5.

### Evaluation Criteria

A: The coverage was 20% or more.

B: The coverage was equal to 10% or more and less than 20%.

C: The coverage was equal to 3% or more and less than 10%.

D: The coverage was less than 3%.

Evaluation of Separatability

Each metal was evaluated for the separatability. The results are shown in Table 5.

### Evaluation Criteria

A: The peeled film adhered at a rate less than 20% with respect to the surface area of the cross-cut tape.

B: The peeled film adhered at a rate of equal to 20% or more and less than 60% with respect to the surface area of the cross-cut tape

C: The peeled film adhered at a rate of 60% or more with respect to the surface area of the cross-cut tape.

TABLE 5

Kind of metal

| | Au | Pt | Cu | Ru |
|---|---|---|---|---|
| Coatability | C | B | C | B |
| Separatability | A | A | C | B |

### Test Example 4

### Examination of Formability

### <Production of Original Master For Producing Mold Structure>

Onto an 8-inch Si (silicon) wafer substrate, an electron beam resist was applied to a thickness of 100 nm by spin coating. Subsequently, the resist applied over the substrate was exposed by a rotary electron beam exposing device, and the resist that had been subjected to exposure was developed, thereby producing a resist Si substrate having a concavo-convex pattern.

Thereafter, the substrate thus produced was subjected to reactive ion etching using the resist as a mask so as to dig concave portions of the concavo-convex pattern deeper (concave portions with an aspect ratio of 2.7 relative to the narrowest line width). After the etching treatment, a resist residue remaining on the substrate was washed with a resist-soluble solvent so as to remove the resist residue. The substrate from which the resist residue had been removed was dried, and the substrate was taken as an original master for producing a mold structure.

Formation of Covering Layer

A covering layer formed of Ni was deposited on the original master for producing a mold structure by sputtering so as to have a thickness of 6 nm. The sputtering conditions employed in the formation of the covering layer are as follows.

Sputtering Conditions (Formation of Covering Layer)
argon pressure: 0.1 Pa
distance between substrate and target: 300 mm
electric power applied (DC power source): 900 W
apparatus: Ni sputtering apparatus (manufactured by Fuji Daiichi Seisakusho Co., Ltd.)

Formation of Barrier Layer

A barrier layer was deposited, with the use of Pt, Ru, Cu, and Au, respectively, on a surface of the covering layer (Ni layer) of the original master for producing a mold structure by sputtering so as to have a thickness shown in Table 6. The sputtering conditions employed in the formation of the barrier layer are as follows.

Sputtering Conditions (Formation of Barrier Layer)
argon pressure: 1.0 Pa
distance between substrate and target: 200 mm electric power applied (DC power source): 500 W
apparatus: sputtering apparatus (OCTAVA II, manufactured by Shibaura Mechatronics Corporation)

As to the resulting original masters for producing a mold structure, a replication yield was measured according to the following manner. Then, the original masters were evaluated in accordance with the following criteria. The evaluation results are shown in Table 6.

### Measurement Method of Replication Yield

The following is a simplified testing method to measure a replication yield. If there is a separating defect present on a surface of a replication plate, and halogen light is directed on the surface of the replication plate, the defective portion appears white opaque. By the use of this method, whether the original master does not appear white opaque (OK) or not (NG) was determined. This determination method was repeated 10 times, and it was checked how many times the original master yielded OK results.

### Evaluation Criteria

A: Replication yield was 80% or more.

B: Replication yield was equal to 40% or more and less than 80%.

C: Replication yield was less than 40%.

TABLE 6

| | Covering layer | | | | | |
|---|---|---|---|---|---|---|
| | (Ni layer) | Barrier layer | | | | |
| | Film | Film | Evaluation of Formability | | | |
| | thickness (nm) | thickness (nm) | Pt | Ru | Cu | Au |
| Sample 1 | 6 | 0 | C | C | C | C |
| Sample 2 | 6 | 1 | B | B | B | B |
| Sample 3 | 6 | 2 | B | B | B | B |
| Sample 4 | 6 | 3 | A | A | B | B |
| Sample 5 | 6 | 5 | A | A | B | B |
| Sample 6 | 6 | 7 | A | A | B | B |
| Sample 7 | 6 | 10 | B | B | B | B |

Since the method for producing a concavo-convex member of the present invention is capable of preventing the reduction in thickness of a covering layer, it can be favorably used for producing magnetic transfer master carriers, mold structures and the like.

What is claimed is:

1. A method for producing a concavo-convex member having a concavo-convex pattern provided, on a surface of a base material, with a plurality of convex portions which are projected upwardly with respect to the surface of the base material, the method comprising:
forming a covering layer on surfaces of at least concave portions of an original master which is for producing a concavo-convex member and has a concavo-convex pattern on a surface thereof;
forming a barrier layer on a surface of the covering layer positioned at the at least concave portions of the original master;
forming a base material by electrodepositing a metal on a surface of the original master which is provided with the covering layer and the barrier layer on the at least concave portions; and
separating, from the original master, the base material provided with the barrier layer and the covering layer over surfaces of at least convex portions,
wherein a metal element contained in the barrier layer has an ionization tendency smaller than an ionization tendency of a metal element contained in the covering layer.

2. The method for producing a concavo-convex member according to claim 1, wherein the base material is a master base material, the concavo-convex member is a magnetic transfer master carrier, and the covering layer is a magnetic layer.

3. The method for producing a concavo-convex member according to claim 2, wherein in the formation of the magnetic layer, a magnetic layer having a thickness of 10 nm or more is formed.

4. The method for producing a concavo-convex member according to claim 2, wherein in the formation of the barrier layer, a barrier layer having a thickness of 4 nm to 20 nm is formed.

5. The method for producing a concavo-convex member according to claim 2, wherein the metal element contained in the magnetic layer is at least one of Fe and Co, and the metal element contained in the barrier layer is at least one selected from Ni, Cu, Ru, Ag, Pt, and Au.

6. The method for producing a concavo-convex member according to claim 1, wherein the base material is a mold base material, and the concavo-convex member is a mold structure.

7. The method for producing a concavo-convex member according to claim 6, wherein in the formation of the barrier layer, a barrier layer having a thickness of 3 nm to 7 nm is formed.

8. The method for producing a concavo-convex member according to claim 6, wherein the metal element contained in the covering layer is Ni, and the metal element contained in the barrier layer is at least one selected from Cu, Ru, Pt, and Au.

9. A concavo-convex member comprising:
a base material,
a concavo-convex pattern provided, on a surface of the base material, with a plurality of convex portions which are projected upwardly with respect to the surface of the base material,
a barrier layer, and
a covering layer,
the barrier layer and the covering layer being provided over surfaces of at least the convex portions of the base material,
wherein a metal element contained in the barrier layer has an ionization tendency smaller than an ionization tendency of a metal element contained in the covering layer.

10. The concavo-convex member according to claim 9, wherein the concavo-convex member is a magnetic transfer master carrier, the base material is a master base material, and the covering layer is a magnetic layer.

11. The concavo-convex member according to claim 10, wherein the magnetic layer has a thickness of 10 nm or more.

12. The concavo-convex member according to claim 10, wherein the barrier layer has a thickness of 4 nm to 20 nm.

13. The concavo-convex member according to claim 10, wherein the metal element contained in the magnetic layer is at least one of Fe and Co, and the metal element contained in the barrier layer is at least one selected from Ni, Cu, Ru, Ag, Pt, and Au.

14. The concavo-convex member according to claim 10, wherein the barrier layer and the magnetic layer are laid in this order over the surfaces of the at least convex portions of the master base material.

15. The concavo-convex member according to claim 9, wherein the concavo-convex member is a mold structure, and the base material is a mold base material.

16. The concavo-convex member according to claim 15, wherein the barrier layer has a thickness of 3 nm to 7 nm.

17. The concavo-convex member according to claim 15, wherein the metal element contained in the covering layer is Ni, and the metal element contained in the barrier layer is at least one selected from Cu, Ru, Pt, and Au.

18. A magnetic transfer method comprising:
initially magnetizing a perpendicular magnetic recording medium by applying a magnetic field;
closely attaching a concavo-convex member to the initially magnetized perpendicular magnetic recording medium; and
transferring magnetic information to the perpendicular magnetic recording medium by applying a perpendicular magnetic field whose direction is opposite to the direction of a magnetic field applied in the initial magnetization, with the perpendicular magnetic recording medium and the concavo-convex member closely attached to each other,
wherein the concavo-convex member comprises a base material, a concavo-convex pattern provided, on a surface of the base material, with a plurality of convex portions which are projected upwardly with respect to the surface of the base material, a barrier layer, and a covering layer, the barrier layer and the covering layer being provided over surfaces of at least the convex portions of the base material,
wherein a metal element contained in the barrier layer has an ionization tendency smaller than an ionization tendency of a metal element contained in the covering layer, and
wherein the concavo-convex member is a magnetic transfer master carrier, the base material is a master base material, and the covering layer is a magnetic layer.
